(19) United States
(12) Patent Application Publication
(10) Pub. No.: US 2026/0252744 A1
(43) Pub. Date: Aug. 27, 2026

(54) CHIPLET SYSTEM HAVING A PLURALITY OF CHIPLETS AND DATA SECURITY METHOD THEREOF

(71) Applicant: REBELLIONS INC., Seongnam-si (KR)

(72) Inventor: Myunghoon CHOI, Seongnam-si (KR)

(21) Appl. No.: 19/546,102

(22) Filed: Feb. 20, 2026

(30) Foreign Application Priority Data
Feb. 27, 2025 (KR) 10-2025-0025726

(51) Int. Cl. G06F 21/85; G06F 9/455; G06F 21/57

(52) U.S. Cl. CPC G06F 21/85; G06F 9/45558; G06F 21/575; G06F 2009/45587; G06F 2221/034

(57) ABSTRACT

The present disclosure relates to a chiplet system including a plurality of chiplets. A chiplet system includes a first chiplet including a ROM in which a bootloader is stored and a first secure core, and connected to a non-volatile memory in which firmware is stored, a second chiplet including a memory controller controlling operation of a volatile memory, a system bus through which data to be stored in the volatile memory is transmitted and received, a memory cryptographic module receiving data from the system bus, encrypting the received data, and transmitting the encrypted data to the memory controller, and a second secure core controlling the memory cryptographic module, a first interface connecting the first chiplet and the second chiplet, and a second interface connecting the first chiplet and the second chiplet.

### CROSS-REFERENCE TO RELATED APPLICATION

The present application claims priority to Korean Application No. 10-2025-0025726, filed on February 27, 2025, in the Korean Intellectual Property Office, the entire disclosure of which is incorporated by reference herein.

### BACKGROUND

### Field

Aspects of some embodiments relate to a chiplet system including a plurality of chiplets and a data security method thereof.

### Description of Related Art

As demands for high performance and miniaturization of semiconductor devices and electronic products using the same have increased, various package technologies related to semiconductor devices have been developed. As part of such technology development, recently, package technology using a chiplet has emerged.

A chiplet system may represent that chips performing various functions are not configured on one die (or substrate), but are configured on each of a plurality of dies (chiplets) by being divided into functional units, and these are packaged into one. That is, a chiplet system is developed to overcome limits of an existing monolithic chip, and dies in a package may be connected through a silicon interposer and may communicate according to a die-to-die communication standard.

Since such a chiplet may be miniaturized by dividing the chiplet into functional units, it is possible to overcome a size limit of a reticle, which is a frame for printing a circuit on a wafer surface using light in a photo process of semiconductor manufacturing. Also, because semiconductor manufacturing yield tends to be inversely proportional to area, if the chiplet is used, the semiconductor manufacturing yield may be increased and manufacturing costs may be reduced. Accordingly, recently, a demand to use chiplets in manufacturing electronic products has increased, and it is desirable to develop technology for a data security method of a chiplet system including a plurality of chiplets.

### SUMMARY

The present disclosure provides a chiplet system including a plurality of chiplets and a data security method thereof for solving the problems as described above.

The present disclosure may be implemented in various ways including a method, an apparatus (system), and/or a computer program stored in a computer-readable storage medium.

According to an embodiment of the present disclosure, a chiplet system including a plurality of chiplets includes a first chiplet including a ROM in which a bootloader is stored and a first secure core, and connected to a non-volatile memory in which firmware is stored, a second chiplet including a memory controller configured to control operation of a volatile memory, a system bus through which data to be stored in the volatile memory is transmitted and received, a memory cryptographic module configured to receive data from the system bus, encrypt the received data, and transmit the encrypted data to the memory controller, and a second secure core configured to control the memory cryptographic module, a first interface configured to connect the first chiplet and the second chiplet, and a second interface connecting the first chiplet and the second chiplet, the second interface being set with a communication speed faster than a communication speed of the first interface, wherein the first secure core is configured to execute the bootloader, load and verify firmware stored in the non-volatile memory based on the bootloader, and transmits the verified firmware to the second chiplet, and the second secure core is configured to activate the second interface based on first firmware received through the first interface, and initialize the memory cryptographic module based on second firmware received through the second interface.

According to an embodiment, the first chiplet further includes a first mailbox, and the second secure core is configured to determine whether initialization of the memory cryptographic module is completed, and if the initialization of the memory cryptographic module is completed, notify that the initialization of the memory cryptographic module is completed using the first mailbox through the second interface.

According to an embodiment, the second chiplet further includes a second mailbox and further includes a third interface configured to connect the first chiplet and a host device, and the first secure core is further configured to receive a data protection request associated with a virtual machine from the host device through the third interface, in response to receiving the data protection request, generate a page table including mapping information between physical addresses and virtual addresses allocated to the virtual machine, and request encryption setting for one or more memory areas allocated to the virtual machine using the second mailbox through the second interface.

According to an embodiment, the second secure core is further configured to in response to receiving the encryption setting request, perform encryption setting for the memory cryptographic module, determine whether the encryption setting for the memory cryptographic module is completed, in response to determining that the encryption setting for the memory cryptographic module is completed, notify that the encryption setting for the memory cryptographic module is completed using the first mailbox through the second interface, and the first secure core is further configured to transmit a response to the data protection request through the third interface.

According to an embodiment, wherein performing the encryption setting for the memory cryptographic module may include at least one of allocating an identifier for distinguishing, among the one or more memory areas, a specific memory area to which encryption is to be applied, defining a range of memory addresses to which encryption is to be applied, setting a cryptographic algorithm to be applied to each of the one more memory areas, or setting a cryptographic key to be applied to each of the one or more memory areas.

According to an embodiment, the memory cryptographic module includes a bus interface configured to communicate with the system bus, a memory interface configured to communicate with the memory controller, and a cryptographic accelerator, and the memory cryptographic module is further configured to determine whether data received through the bus interface is data subject to encryption, in response to determining that the data received through the bus interface is the data subject to encryption, perform encryption on the data through the cryptographic accelerator, and transmit the encrypted data to the memory controller through the memory interface.

According to an embodiment, whether the data received through the bus interface is the data subject to encryption is determined based on whether a physical address of the corresponding data is included in a preset encrypted memory area associated with the one or more memory areas, and the cryptographic accelerator may perform data encryption based on a preset cryptographic key and a preset cryptographic algorithm.

According to an embodiment, the memory cryptographic module includes a bus interface configured to communicate with the system bus, a memory interface configured to communicate with the memory controller, and a cryptographic accelerator, and the memory cryptographic module may, if data received through the memory interface is encrypted data, perform data decryption through the cryptographic accelerator, and transmit the decrypted data to the system bus through the bus interface.

According to an embodiment, the third interface includes a PCIe (peripheral component interconnect express) interface and may be configured to receive a data protection request associated with a trusted execution environment from the host device based on a security protocol.

According to an embodiment, the first interface is an interface configured so that the first chiplet and the second chiplet communicate in a process of booting or system initialization, and after the second interface is activated, the first chiplet and the second chiplet may communicate with each other through the second interface.

According to an embodiment, the first interface includes aserial peripheral interface (SPI), and the second interface may include a universal chiplet interconnect express (UCIe) interface.

According to an embodiment of the present disclosure, a data security method of a chiplet system including a first chiplet and a second chiplet includes executing, by a first secure core of the first chiplet, a bootloader stored in a read-only memory (ROM) included in the first chiplet, loading and verifying, by the first secure core, firmware stored in a non-volatile memory connected to the first chiplet based on the bootloader, transmitting, by the first secure core, the verified firmware to the second chiplet through a first interface, receiving, by a second secure core of the second chiplet, first firmware through the first interface and activating the second interface based on the first firmware, and receiving, by the second secure core, second firmware through the second interface and initializing a memory cryptographic module included in the second chiplet based on the second firmware, wherein the first interface is configured to connect the first chiplet and the second chiplet, the second interface is configured to connect the first chiplet and the second chiplet, and a communication speed faster than the first interface is set for the communication speed of the second interface.

According to an embodiment, the first chiplet further includes a first mailbox, and the method may further include determining, by the second secure core, whether initialization of the memory cryptographic module is completed, and if the initialization of the memory cryptographic module is completed, notifying, by the second secure core, that the initialization of the memory cryptographic module is completed using the first mailbox through the second interface.

According to an embodiment, the second chiplet further includes a second mailbox, and the method may further include receiving, by the first secure core, a data protection request associated with a virtual machine from a host device through a third interface, in response to receiving the data protection request, generating, by the first secure core, a page table including mapping information between physical addresses and virtual addresses allocated to the virtual machine, and requesting, by the first secure core, encryption setting for one or more memory areas allocated to the virtual machine using the second mailbox through the second interface.

According to an embodiment, the method may further include, in response to receiving the encryption setting request, performing, by the second secure core, encryption setting for the memory cryptographic module, determining, by the second secure core, whether the encryption setting for the memory cryptographic module is completed, in response to determining that the encryption setting for the memory cryptographic module is completed, notifying, by the second secure core, that the encryption setting for the memory cryptographic module is completed using the first mailbox through the second interface, and transmitting, by the first secure core, a response to the data protection request through the third interface.

According to an embodiment, the performing of the encryption setting for the memory cryptographic module includes at least one of allocating an identifier for distinguishing, among the one or more memory areas, a specific memory area to which encryption is to be applied, defining a range of memory addresses to which encryption is to be applied, setting a cryptographic algorithm to be applied to each of the one or more memory areas, or setting a cryptographic key to be applied to each of the one or more memory areas.

According to an embodiment, the memory cryptographic module includes a bus interface configured to communicate with a system bus, a memory interface configured to communicate with a memory controller, and a cryptographic accelerator, and the method may further include determining, by the memory cryptographic module, whether data received through the bus interface is data subject to encryption, in response to determining that the data received through the bus interface is the data subject to encryption, performing, by the memory cryptographic module, encryption on the data through the cryptographic accelerator, and transmitting, by the memory cryptographic module, the encrypted data to the memory controller through the memory interface.

According to an embodiment, the memory cryptographic module includes a bus interface configured to communicate with a system bus, a memory interface configured to communicate with a memory controller, and a cryptographic accelerator, and the method may further include, if data received through the memory interface is encrypted data, performing, by the memory cryptographic module, data decryption through the cryptographic accelerator, and transmitting, by the memory cryptographic module, the decrypted data to the system bus through the bus interface.

According to various embodiments of the present disclosure, while memory expansion is supported in a chiplet system, data protection in an artificial intelligence computation process may be effectively performed.

Effects of the present disclosure are not limited to the effects mentioned above, and other effects not mentioned will be clearly understood by those of ordinary skill in the art to which the present disclosure belongs (referred to as a "person skilled in the art") from the description of the claims.

### BRIEF DESCRIPTION OF THE DRAWINGS

Embodiments of the present disclosure will be described with reference to the accompanying drawings described below, wherein similar reference numbers represent similar elements, but are not limited thereto.

FIG. 1 illustrates a chiplet system according to some embodiments of the present disclosure.

FIG. 2 illustrates components of a chiplet system according to some embodiments of the present disclosure.

FIG. 3 illustrates a data protection method according to some embodiments of the present disclosure.

FIG. 4 illustrates components of a chiplet system according to some embodiments of the present disclosure.

FIG. 5 illustrates a process in which an initial operation of a secure boot process is performed after power is supplied according to some embodiments of the present disclosure.

FIG. 6 illustrates a process in which a second interface is activated and a memory cryptographic module is initialized through a secure boot process after power is supplied according to some embodiments of the present disclosure.

FIG. 7 illustrates a data protection process associated with a virtual machine according to some embodiments of the present disclosure.

FIG. 8 illustrates a memory cryptographic module in which encryption setting values are stored according to some embodiments of the present disclosure.

FIG. 9 illustrates an encryption setting method according to some embodiments of the present disclosure.

FIG. 10 illustrates a data encryption process according to some embodiments of the present disclosure.

FIG. 11 illustrates a data decryption process according to some embodiments of the present disclosure.

FIG. 12 illustrates a data encryption method according to some embodiments of the present disclosure.

FIG. 13 illustrates a data decryption method according to some embodiments of the present disclosure.

### DETAILED DESCRIPTION

Hereinafter, specific details for implementation of the present disclosure will be described in detail with reference to the accompanying drawings. However, in the following description, if there is a risk of unnecessarily obscuring the gist of the present disclosure, detailed descriptions regarding widely known functions or configurations will be omitted.

In the accompanying drawings, the same or corresponding components are given the same reference numerals. Also, in the description of the following embodiments, redundant description of the same or corresponding components may be omitted. However, even if descriptions regarding components are omitted, it is not intended that such components are not included in a certain embodiment.

Advantages and features of the disclosed embodiments, and methods of achieving them, will become clear with reference to the embodiments described below in conjunction with the accompanying drawings. However, the present disclosure is not limited to the embodiments disclosed below but may be implemented in various different forms, and these embodiments are merely provided so that the present disclosure is complete and to fully inform a person skilled in the art of the scope of the invention.

Terms used in the present specification will be briefly described, and the disclosed embodiments will be described in detail. The terms used in the present specification have been selected as general terms that are currently widely used as much as possible while considering functions in the present disclosure, but this may vary according to the intention of a technician engaged in the related field, precedents, or emergence of new technology. Also, in specific cases, there are terms arbitrarily selected by the applicant, and in this case, the meaning will be described in detail in the description part of the corresponding invention. Therefore, the terms used in the present disclosure should be defined based on the meaning the terms have and the contents throughout the present disclosure, rather than simple names of the terms.

Singular expressions in the present specification include plural expressions unless specifically specified to be singular in context. Also, plural expressions include singular expressions unless specifically specified to be plural in context. Throughout the specification, if a certain part includes a certain component, this means that other components are not excluded but may be further included unless specifically stated otherwise.

Also, the terms "module" or "part" used in the specification mean software or hardware components, and a "module" or "part" performs certain roles. However, a "module" or "part" is not limited to a meaning of software or hardware. A "module" or "part" may be configured to be in an addressable storage medium or may be configured to reproduce one or more processors. Thus, as an example, a "module" or "part" may include at least one of components such as software components, object-oriented software components, class components, and task components, processes, functions, attributes, procedures, subroutines, segments of program code, drivers, firmware, microcode, circuits, data, databases, data structures, tables, arrays, or variables. The functions provided in the components and "modules" or "parts" may be combined into a smaller number of components and "modules" or "parts" or may be further separated into additional components and "modules" or "parts."

According to an embodiment of the present disclosure, a "module" or "part" may be implemented with a processor and a memory. A "processor" should be interpreted broadly to include a general-purpose processor, a central processing unit (CPU), a microprocessor, a digital signal processor (DSP), a controller, a microcontroller, a state machine, and the like. In some environments, a "processor" may also refer to an application specific integrated circuit (ASIC), a programmable logic device (PLD), a field programmable gate array (FPGA), and the like. A "processor" may refer to a combination of processing devices, such as, for example, a combination of a DSP and a microprocessor, a combination of a plurality of microprocessors, a combination of one or more microprocessors combined with a DSP core, or any other combination of such configurations. Also, a "memory" should be interpreted broadly to include any electronic component capable of storing electronic information. A "memory" may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. If the processor can read information from the memory and/or write information to the memory, the memory is said to be in electronic communication with the processor. A memory integrated into a processor is in electronic communication with the processor.

Also, terms such as first, second, A, B, (a), (b) used in the following embodiments are only used to distinguish a component from another component, and the essence, order, or sequence of the corresponding component is not limited by the term.

Also, in the following embodiments, when it is described that a component is "connected," "coupled," or "joined" to another component, the component may be directly connected or joined to the other component, but it should be understood that another component may be "connected," "coupled," or "joined" between each component.

Also, "comprises" and/or "comprising" used in the following embodiments do not exclude the existence or addition of one or more other components, steps, operations, and/or elements from mentioned components, steps, operations, and/or elements.

Hereinafter, various embodiments of the present disclosure will be described in detail according to the accompanying drawings.

In the present disclosure, a "chiplet" is an integrated circuit (IC) block and may be a type of semiconductor device that constitutes one package by being combined/connected/associated with other chiplets. Dies in a chiplet system may be connected through a silicon interposer, and may communicate according to a die-to-die communication standard such as universal chiplet interconnect express (UCIe).

In the present disclosure, "non-volatile memory" may be a memory that continues to maintain stored information even if power is not supplied. For example, the non-volatile memory may include at least one of ROM (Read-Only Memory), PROM (Programmable Read-Only Memory), EAROM (Erasable Alterable ROM), EPROM (Erasable Programmable Read-Only Memory), EEPROM (Electrically Erasable Programmable Read-Only Memory) (e.g., NAND Flash memory, NOR Flash memory, etc.), UVEPROM (Ultra-Violet Erasable Programmable Read-Only Memory), FeRAM (Ferroelectric Random Access Memory), MRAM (Magnetoresistive Random Access Memory), PRAM (Phase-change Random Access Memory), SONOS (silicon-oxide-nitride-oxide-silicon), RRAM (Resistive Random Access Memory), NRAM (Nanotube Random Access Memory), magnetic computer storage devices (e.g., hard disk, diskette drive, magnetic tape, etc.), optical disk drives, and 3D XPoint memory. However, the present disclosure is not limited thereto.

In the present disclosure, "volatile memory" may be a memory that continuously requires power to maintain stored information. For example, "volatile memory" may include at least one of DRAM (Dynamic Random Access Memory), SRAM (Static Random Access Memory), SDRAM (Synchronous Dynamic Random Access Memory), and DDR SDRAM (Double Data Rate SDRAM). However, the present disclosure is not limited thereto.

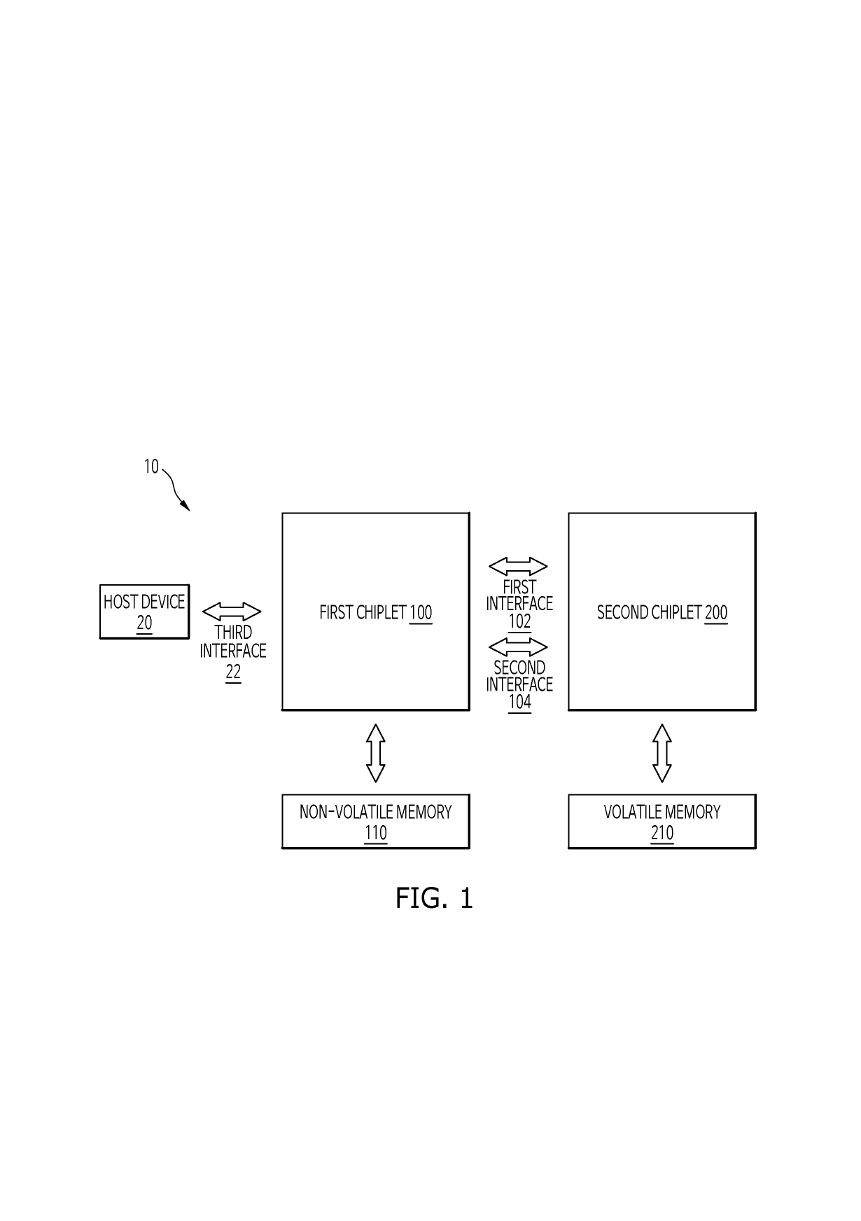

FIG. 1 illustrates a chiplet system according to some embodiments of the present disclosure.

Referring to FIG. 1, a chiplet system 10 includes a first chiplet 100 and a second chiplet 200, and may be connected to a host device 20. In FIG. 1, the first chiplet 100 and the second chiplet 200 are illustrated for convenience of description, but not limited thereto, and the chiplet system 10 may include any number of chiplets.

As illustrated in FIG. 1, the first chiplet 100 and the second chiplet 200 may communicate with each other through a first interface 102 and a second interface 104. Here, a communication speed of the second interface 104 may be set faster than a communication speed of the first interface 102. In some embodiments, the first interface 102 may be an interface configured so that the first chiplet 100 and the second chiplet 200 communicate in a process of booting or system initialization. Accordingly, in a process of booting or initialization of the chiplet system 10, the first chiplet 100 and the second chiplet 200 communicate with each other through the first interface 102, and after the second interface 104 is activated, the first chiplet 100 and the second chiplet 200 may communicate with each other through the second interface 104.

The first chiplet 100 may be connected to an external device (e.g., the host device 20) through a third interface 22. According to an embodiment, the third interface 22 may refer to a host interface, and for example, may include a PCIe (Peripheral Component Interconnect express) interface, a CXL (Compute Express Link) interface, and the like.

The first chiplet 100 may be a chiplet specialized for artificial intelligence computation. In some embodiments, the first chiplet 100 may include a neural processing unit (NPU) for accelerating artificial intelligence computation. Also, the first chiplet 100 may include a normal core performing general computation and a security core in charge of security-related computation. In some embodiments, the first chiplet 100 may be connected to the host device 20 to receive and process commands, and may be connected to a non-volatile memory 110 to perform processes of system booting and firmware loading.

The second chiplet 200 may be a memory expander chiplet. The second chiplet 200 is connected to the first chiplet 100 and may provide a large-capacity memory for artificial intelligence computation. In particular, to support computation of a large-scale artificial intelligence model such as a large language model (LLM), a memory space for storing more parameters needs to be allocated, and accordingly, the second chiplet 200 may be configured to provide additional memory resources. The second chiplet 200 is connected to a volatile memory 210, and may perform a role of storing and managing data used in an artificial intelligence computation process in the volatile memory 210.

According to various embodiments of the present disclosure, a data security method for protecting data-in-use stored in the volatile memory 210 may be provided. The second chiplet 200 may be connected to the volatile memory 210 to store and manage data for artificial intelligence computation, and security-enhanced data processing may be performed through communication with the first chiplet 100. Through this, in the chiplet system 10 according to the present disclosure, while memory expansion is supported, data protection in an artificial intelligence computation process may be effectively performed.

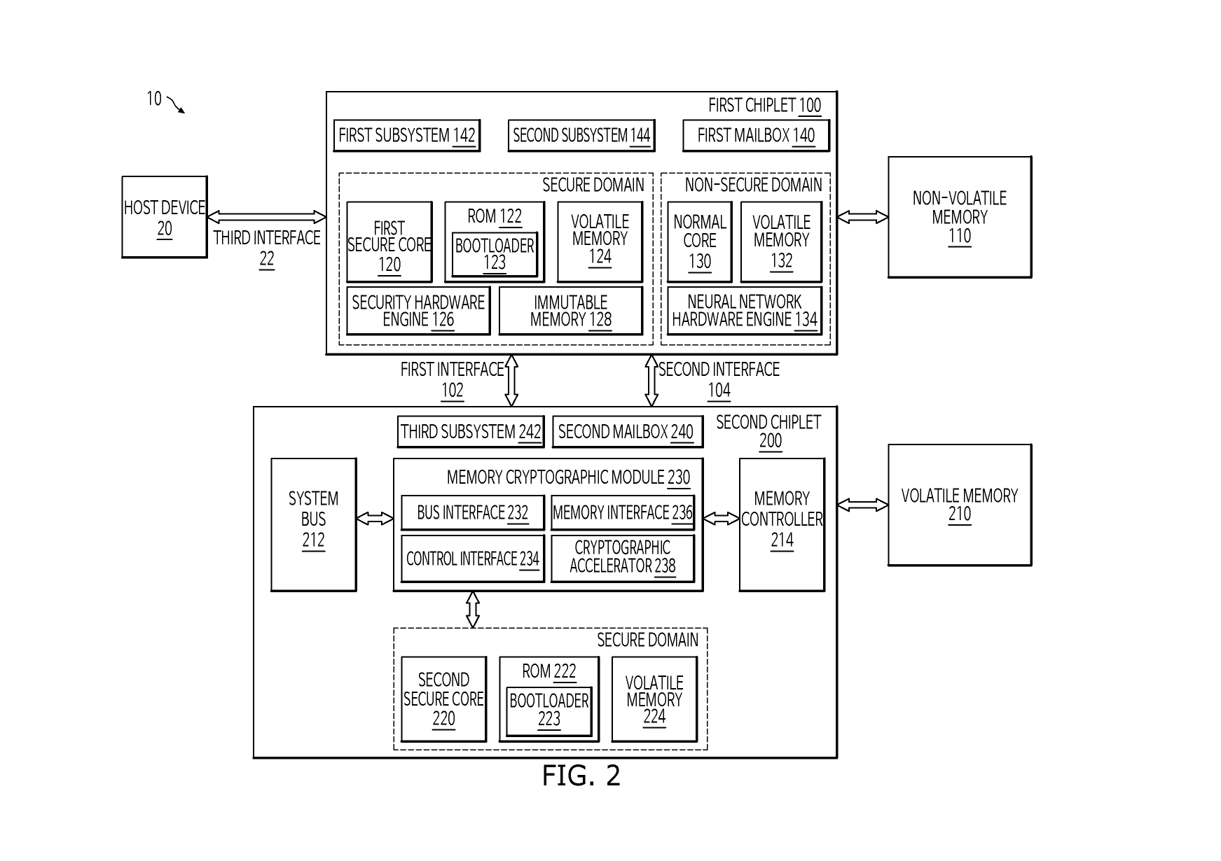

FIG. 2 illustrates components of a chiplet system according to some embodiments of the present disclosure.

Referring to FIG. 2, a chiplet system 10 may include a plurality of chiplets, for example, a first chiplet 100 and a second chiplet 200. However, the number of chiplets included in the chiplet system 10 is not limited thereto. According to various embodiments, the chiplet system 10 may further include at least one chiplet in addition to the above-described chiplets. The chiplet system 10 including a plurality of chiplets 100 and 200 may be packaged, and accordingly, may be referred to as a packaging device.

The chiplet system 10 may include a homogeneous chiplet system configured by connecting several chiplets performing the same structure or function, or a heterogeneous chiplet system in which at least one of a plurality of chiplets includes a chiplet performing a different structure or function. In the case of a heterogeneous chiplet system, an optimized design may be implemented by allocating hardware resources suitable for the purpose of the chiplet.

For example, if the chiplet system 10 includes a chiplet for memory expansion, for large-scale data processing, a chiplet mainly in charge of artificial intelligence computation and a chiplet for memory expansion may be designed with mutually optimized structures. A chiplet mainly in charge of artificial intelligence computation may include a neural processing unit or the like performing artificial intelligence computation, and a chiplet for memory expansion is connected to a volatile memory 210 to store and manage a large amount of data, and may include a memory controller for managing memory access operations. In the following description, a case where the chiplet system 10 is configured as a system including at least one heterogeneous chiplet will be described. More specifically, the first chiplet 100 may be a chiplet specialized for artificial intelligence computation, and may be configured to be connected to a host device 20 to process computation requests. The second chiplet 200 may be a chiplet for memory expansion, and may be configured to be connected to the volatile memory 210 to perform large-capacity data storage and management functions.

A plurality of chiplets (e.g., the first chiplet 100 and the second chiplet 200) included in the chiplet system 10 may be connected to each other through a first interface 102 and a second interface 104. For example, the first chiplet 100 and the second chiplet 200 may communicate with each other through the first interface 102. Also, the first chiplet 100 and the second chiplet 200 may communicate with each other through the second interface 104.

According to an embodiment, the first interface 102 is a backup interface, and a data transmission and reception speed may be set slower than the second interface 104 for connection between chiplets. That is, for the second interface 104, a communication speed faster than a communication speed of the first interface 102 may be set. For example, the first interface 102 may include an SPI (Serial Peripheral Interface). However, the present disclosure is not limited thereto, and the first interface 102 may include secure JTAG (secure Joint Test Action Group), GPIO (General Purpose Input/Output), I2C (Inter-Integrated Circuit), UART (Universal Asynchronous Receiver/Transmitter), and the like.

According to an embodiment, the second interface 104 may be referred to as a die-to-die interface, and for example, may include UCIe (Universal Chiplet Interconnect Express) and the like.

One chiplet (e.g., the first chiplet 100) among a plurality of chiplets 100 and 200 included in the chiplet system 10 may be connected to the host device 20 through a third interface 22. At this time, the remaining chiplet (e.g., the second chiplet 200) may not perform direct communication with the host device 20. For example, in a heterogeneous chiplet system, the first chiplet 100 may be in charge of an input/output function with the host device 20 and artificial intelligence computation, and the second chiplet 200 may mainly perform a memory expansion function. According to an embodiment, the third interface 22 may be referred to as a host interface, and for example, may include a PCIe (Peripheral Component Interconnect Express), a CXL (Compute Express Link) interface, and the like, but is not limited thereto. Also, the third interface may be configured to receive a data protection request associated with a trusted execution environment from a host device based on a security protocol.

The first chiplet 100 may be divided into a secure domain and a non-secure domain. The secure domain of the first chiplet 100 is in charge of a security function of the chiplet system 10, and may include a first secure core 120, a ROM 122, a volatile memory 124, a security hardware engine 126, and an immutable memory 128. However, a configuration included in the secure domain of the first chiplet 100 is not limited thereto. According to various embodiments, at least one of the above-described components may be omitted in the secure domain of the first chiplet 100, and at least one other component may be further included. The secure domain is an area where security-related tasks are performed, and other components inside and outside the system excluding the first secure core 120 may access the first secure core 120 only in a limited way. For example, an access request for encrypted data managed within the secure domain may be made only through the first secure core 120, and direct access excluding this may be restricted. Through such a structure, the security domain may function as the most reliable root in the chiplet system 10.

The first secure core 120 is a processor that performs security-related computation, and may be configured to independently execute a security function or perform a role of managing security computation and distributing tasks. For example, the first secure core 120 may perform integrity verification on data stored in the volatile memory 124 periodically or if necessary, and through this, may guarantee data integrity within the chiplet system 10.

In particular, in a booting process, the first secure core 120 may exclusively handle a Secure Boot process, and for this, a security hardware engine 126 may be included within the security domain. In a secure boot process, the first secure core 120 may verify integrity of firmware stored in the non-volatile memory 110 by executing a bootloader 123 stored in the ROM 122. Also, if a security-related problem is detected, the first secure core 120 may perform protection measures to maintain stability of the system. For example, if integrity verification failure occurs, a specific process may be blocked so that the corresponding error does not affect system operation, or a recovery procedure may be executed if necessary. Through this, the first secure core 120 has the highest priority within the chiplet system 10 and may be in charge of various security functions including secure boot, data protection, and encryption computation.

The ROM 122 may store code and data for booting of the chiplet system 10. For example, a bootloader 123 may be stored in the ROM 122, and integrity verification and initialization tasks may be performed by being executed in a secure boot process.

The volatile memory 124 may perform a role of temporarily storing important data while security-related tasks are processed within the security domain. According to an embodiment, the volatile memory 124 may include an SRAM and may be utilized if fast data access is needed during security computation.

The security hardware engine 126 is a dedicated hardware module that accelerates and protects security tasks at a hardware level, and may be configured to perform a role of processing sensitive data and encryption computation. For example, the security hardware engine 126 may support security functions such as encryption and decryption, digital signature and authentication, key management and storage, random number generation, and access control.

The immutable memory 128 may store security information (e.g., a cryptographic key or security firmware) and may be protected so that only the first secure core 120 can access it within the security domain. According to an embodiment, the immutable memory 128 may include a one-time programmable (OTP) memory, and a write protection function may be applied to prevent tampering of a security key and firmware.

The non-secure domain of the first chiplet 100 is in charge of general computation functions and may include a normal core 130, a volatile memory 132, and a neural network hardware engine 134. However, a configuration included in the non-secure domain of the first chiplet 100 is not limited thereto. According to various embodiments, at least one of the above-described components may be omitted in the non-secure domain of the first chiplet 100, and at least one other component may be further included.

The normal core 130 is a processor that performs computation tasks and may be configured to process general computation or perform a role of managing cores that perform specific tasks and distributing tasks. For example, the normal core 130 may perform computation by loading data stored in the volatile memory 132, or control operation of other hardware modules. However, the type or function of the normal core 130 is not limited thereto.

The volatile memory 132 may include a memory for storing and processing data and/or software during operation of the normal core 130 and the first secure core 120. That is, data-in-use may be stored in the volatile memory 132. For example, data used for artificial intelligence computation may be stored in the volatile memory 132. According to an embodiment, the volatile memory 132 may include at least one of static RAM (SRAM) or dynamic RAM (DRAM).

The neural network hardware engine 134 may be dedicated hardware designed to accelerate artificial intelligence and machine learning tasks, especially computation of a neural network model. According to an embodiment, the neural network hardware engine 134 may include a neural processing unit (NPU), and through this, large-scale artificial intelligence computation may be performed more efficiently.

In addition to this, the first chiplet 100 may include various components for communication between chiplets and system control. For example, the first chiplet 100 may further include a first mailbox 140, a first subsystem 142, a second subsystem 144, and the like.

The first mailbox 140 is a component for communication between different cores, and may perform a role of delivering messages inside a chiplet or between chiplets or notifying a specific event. For example, if a transmission core records a message in a mailbox, an interrupt may be generated to inform a reception core of message arrival.

The first subsystem 142 may be a subsystem for communication with an external system (e.g., the host device 20), and through this, the chiplet system 10 may transmit and receive data with the external system. According to an embodiment, the first subsystem 142 may be a PCIe subsystem, but is not limited thereto.

The second subsystem 144 may be a subsystem for communication with another chiplet (e.g., the second chiplet 200), and may perform high-speed data transmission between chiplets and support efficient data exchange for artificial intelligence computation, memory expansion, and the like. According to an embodiment, the second subsystem 144 may be a UCIe subsystem, but is not limited thereto.

The second chiplet 200 may include a second secure core 220, a ROM 222, a volatile memory 224, a memory cryptographic module 230, a system bus 212, a memory controller 214, a second mailbox 240, and a third subsystem 242. Also, the second chiplet 200 may include a secure domain, and the second secure core 220, the ROM 222, and the volatile memory 224 may be disposed in the secure domain of the second chiplet 200. However, a configuration included in the secure domain of the second chiplet 200 is not limited thereto. According to various embodiments, at least one of the above-described components may be omitted in the secure domain of the second chiplet 200, and at least one other component may be further included. The secure domain is an area where security-related tasks are performed, and other components inside and outside the system excluding the second secure core 220 may access the second secure core 220 only in a limited way. For example, an access request for encrypted data managed within the secure domain may be made only through the second secure core 220, and direct access excluding this may be restricted. Also, at least one of the above-described components may be omitted in the second chiplet 200, and at least one other component may be further included.

The second secure core 220 is a processor that performs security-related tasks for data stored through the second chiplet 200, and may be configured to independently execute a security function or manage security tasks and perform roles. For example, the second secure core 220 may initialize the memory cryptographic module 230 in a booting process by controlling the memory cryptographic module 230.

The ROM 222 may store code and data for booting of the chiplet system, and may support a secure boot process in a booting process. For example, a bootloader 223 may be stored in the ROM 222, and integrity verification and initialization tasks may be performed by being executed in a secure boot process.

The volatile memory 224 may be utilized for a purpose of temporarily storing security-related data. According to an embodiment, the volatile memory 224 may include an SRAM, but is not limited thereto.

The memory cryptographic module 230 may be configured to perform a role of encrypting and/or decrypting data to protect data used for artificial intelligence computation in the chiplet system 10. The memory cryptographic module 230 may include a bus interface 232 for communicating with the system bus 212, a control interface 234 for communicating with the second secure core 220, a memory interface 236 for communicating with the memory controller 214, and a cryptographic accelerator 238 that accelerates encryption and decryption computations.

The system bus 212 is a data path through which data is transmitted to and received from the second chiplet 200, data input from the outside is delivered through the system bus 212, and the corresponding data may be stored in the volatile memory 210 by the memory controller 214 after going through an encryption process in the memory cryptographic module 230. The volatile memory 210 may store data used for artificial intelligence computation in the system. According to an embodiment, the volatile memory 210 may include at least one of DRAM or SRAM, but is not limited thereto.

The second mailbox 240 is a component for communication between different cores, and may perform a role of delivering messages inside a chiplet or between chiplets or notifying a specific event. For example, if a transmission core records a message in a mailbox, an interrupt may be generated to inform a reception core of message arrival.

The third subsystem 242 may be a subsystem for communication with another chiplet (e.g., the first chiplet 100), and may perform high-speed data transmission between chiplets and support efficient data exchange for artificial intelligence computation, memory expansion, and the like. According to an embodiment, the third subsystem 242 may be a UCIe subsystem, but is not limited thereto.

If power is supplied and a signal associated with booting (e.g., a booting signal, a reset signal, and the like) is received, the chiplet system 10 may perform a secure boot process. A secure boot process may be a process for enhancing security of the chiplet system 10 by verifying integrity of a program or software to be executed.

In a secure boot process, the first chiplet 100 may verify integrity of firmware stored in the non-volatile memory 110 by executing the bootloader 123 stored in the ROM 122. The integrity check may be performed using a public-key cryptography (PKC) method, a hash algorithm, and the like, and for example, the first chiplet 100 may verify integrity by calculating a hash value of firmware and decrypting and comparing a stored signature. The firmware that has passed integrity verification may be transmitted to the second chiplet 200 through the first interface 102 and/or the second interface 104, and the second secure core 220 may perform initialization of the memory cryptographic module 230 using the firmware. If initialization is completed, the second chiplet 200 may notify the first chiplet 100 whether the initialization is completed using the first mailbox 140, and thereafter the chiplet system 10 may operate normally.

After a secure boot process is completed, the chiplet system 10 may operate normally, and according to a request of the host device 20 and/or according to a need during artificial intelligence computation, the first chiplet 100 may transmit data to the second chiplet 200 and have the corresponding data stored in the volatile memory 210.

In a data storage process, the second chiplet 200 may store received data in the volatile memory 210 after encrypting the received data. To this end, the memory cryptographic module 230 included in the second chiplet 200 receives data through the bus interface 232, performs data encryption using the cryptographic accelerator 238, and then may store the encrypted data in the volatile memory 210 through the memory controller 214. Also, if there is a request for stored data, the second chiplet 200 may decrypt the encrypted data stored in the volatile memory 210 and transmit the decrypted data to the first chiplet 100. At this time, the memory cryptographic module 230 brings data through the memory interface 236, decrypts the data using the cryptographic accelerator 238, and then may deliver the data to the first chiplet 100 through the bus interface 232. Through this, the chiplet system 10 may operate so that storage and retrieval of data are possible in a state where security is enhanced.

According to various embodiments of the present disclosure, in a chiplet system 10 including a memory expansion chiplet (e.g., the second chiplet 200) for artificial intelligence computation, an architecture and an operation method for enhancing data security may be provided.

In some embodiments, the chiplet system 10 may guarantee reliability of the system by performing a secure boot process. For example, the first chiplet 100 may verify integrity of firmware stored in the non-volatile memory 110 in a booting process and transmit the verified firmware to the second chiplet 200. The second chiplet 200 may perform an operation of initializing the memory cryptographic module 230 and completing security settings by executing the received firmware. Through this, the chiplet system 10 may be booted in a reliable state, and the memory cryptographic module 230 may be set to operate normally.

Also, during normal operation, a security mechanism for protecting data used for artificial intelligence computation may be applied. The first chiplet 100 may transmit data to the second chiplet 200 according to a request of the host device 20 or according to a need during artificial intelligence computation, and the second chiplet 200 may store the received data in the volatile memory 210 by encrypting the received data, or deliver stored data to the first chiplet 100 by decrypting the stored data. In this process, the memory cryptographic module 230 may perform encryption and decryption using the cryptographic accelerator 238.

Through such a configuration, the chiplet system 10 may expand a large-capacity memory for artificial intelligence computation while enhancing security of data stored in the memory, and may support secure data exchange between chiplets.

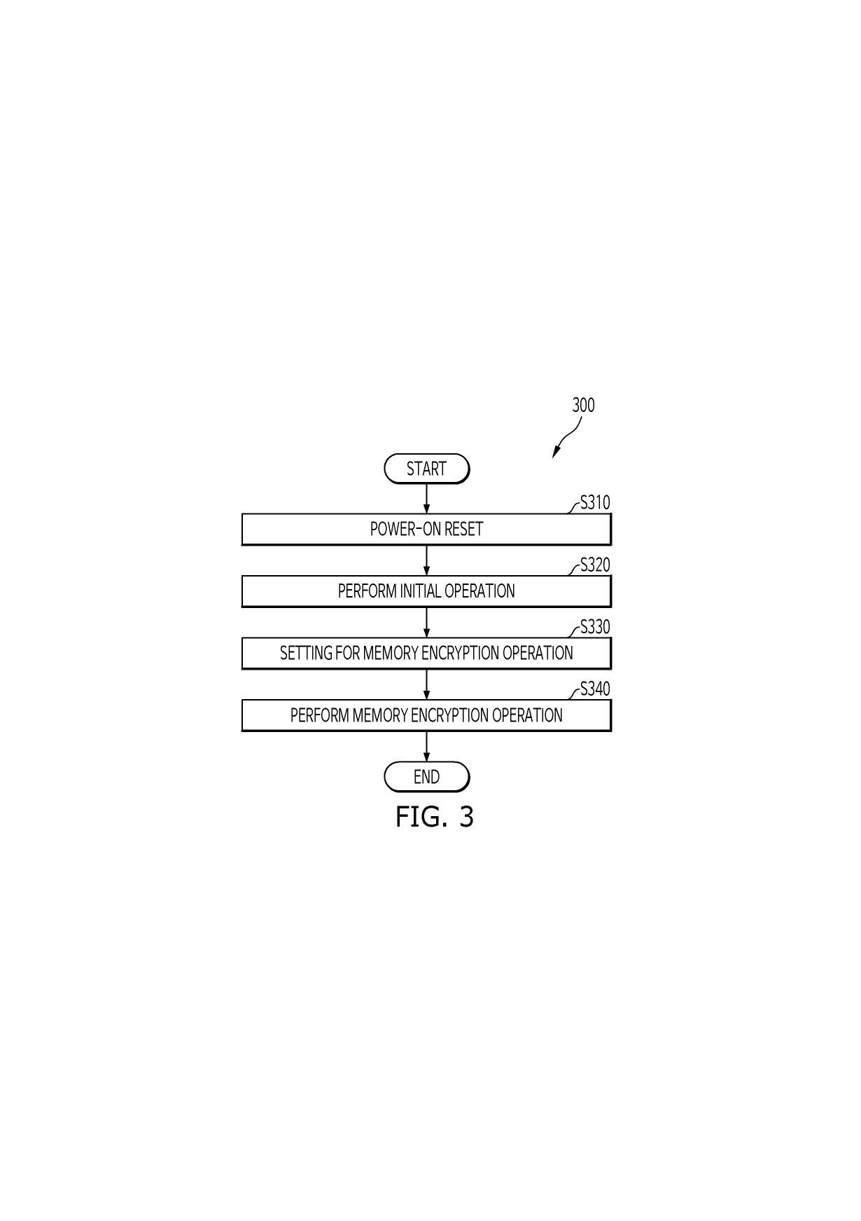

FIG. 3 illustrates a data protection method according to some embodiments of the present disclosure.

Referring to FIG. 3, a data protection method 300 may be initiated by power being supplied and a signal associated with booting (e.g., a Power-on Reset signal, a booting signal, a reset signal, and the like) being received (S310). In some embodiments, if power is supplied and a signal associated with booting is received, a chiplet system (e.g., the chiplet system 10 of FIG. 2) may perform a secure boot process.

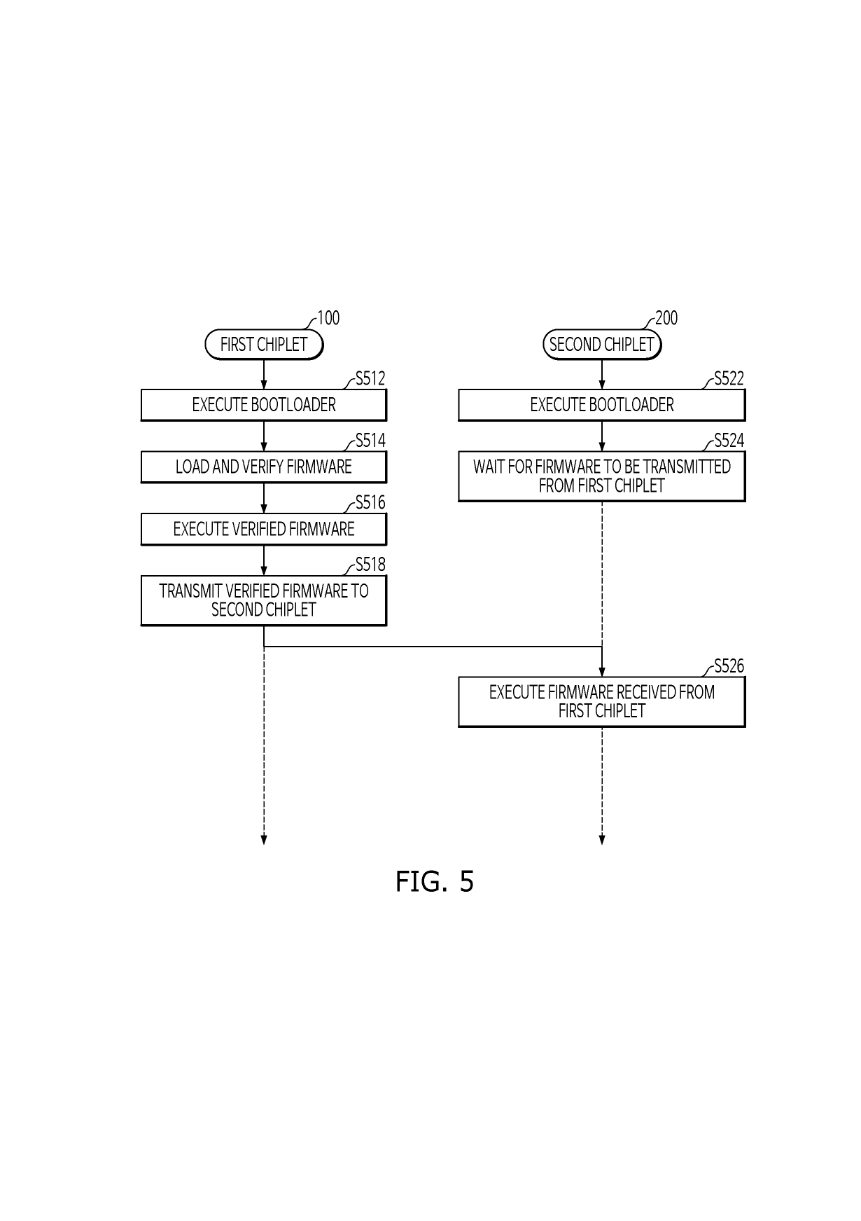

Also, the chiplet system may perform an initial operation for the secure boot process (S320). In some embodiments, each of a first chiplet (e.g., the first chiplet 100 of FIG. 2) and a second chiplet (e.g., the second chiplet 200 of FIG. 2) may execute a bootloader if power is supplied. Also, the first chiplet may load and verify firmware stored in a non-volatile memory and transmit the firmware to the second chiplet. An initial operation for the secure boot process will be described in detail later with reference to FIG. 5.

Also, the chiplet system may perform setting for a memory encryption operation (S330). Specifically, the second chiplet may perform initial setting for a memory encryption operation by executing firmware received from the first chiplet. In some embodiments, the second chiplet may initialize a memory cryptographic module (e.g., the memory cryptographic module 230 of FIG. 2) by executing firmware, and perform encryption setting for the memory cryptographic module. In some embodiments, performing encryption setting for the memory cryptographic module may include at least one of allocating an identifier for distinguishing, among one or more memory area, a specific memory area to which encryption is to be applied, defining a range of memory addresses to which encryption is to be applied, setting a cryptographic algorithm to be applied to each of the one or more memory area, or setting a cryptographic key to be applied to each of the one or more memory area, but is not limited thereto.

Also, the chiplet system may, after the setting for the memory encryption operation is performed, perform a memory encryption operation (S340). For example, the first chiplet may transmit data to the second chiplet according to a request of a host device or according to a need during artificial intelligence computation, and the second chiplet may store the received data in a volatile memory by encrypting the received data, or deliver stored data to the first chiplet by decrypting the stored data.

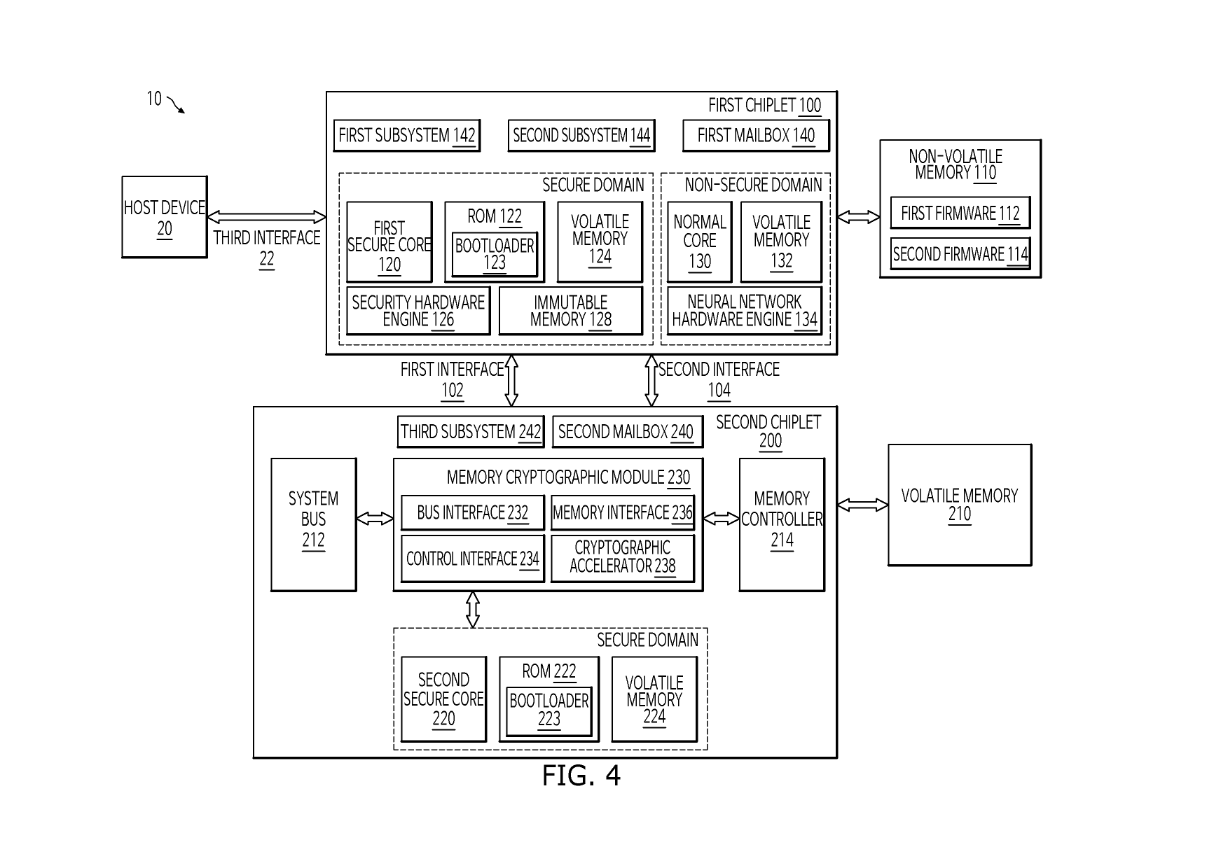

FIG. 4 illustrates components of a chiplet system according to some embodiments of the present disclosure. Descriptions redundant with descriptions above are briefly described or omitted.

Referring to FIG. 4, a non-volatile memory 110 may store first firmware 112 and second firmware 114.

In some embodiments, a first secure core 120 performs a secure boot process, and after executing a bootloader 123, may load and verify the first firmware 112 from the non-volatile memory 110. After verification is completed, the first secure core 120 may execute the verified first firmware 112. Here, the first firmware 112 may be firmware for activation of a second interface 104 that supports high-speed data transmission between a first chiplet 100 and a second chiplet 200. The first secure core 120 may transmit the first firmware 112 to the second chiplet 200 through a first interface 102.

A second secure core 220 may receive the first firmware 112 through the first interface 102, and activate the second interface 104 by executing the first firmware 112. After the second interface 104 is activated, the first chiplet 100 and the second chiplet 200 may communicate with each other through the second interface 104. Here, for the second interface 104, a communication speed faster than a communication speed of the first interface 102 may be set.

The first secure core 120 may load and verify the second firmware 114 from the non-volatile memory 110. Also, the first secure core 120 may transmit the verified second firmware 114 to the second chiplet 200 through the second interface 104. Here, the second firmware 114 may be firmware associated with initial setting of a memory cryptographic module 230 included in the second chiplet 200.

The second secure core 220 may receive the second firmware 114 through the second interface 104, and initialize the memory cryptographic module 230 and perform initial encryption setting of the memory cryptographic module 230 by executing the second firmware 114.

FIG. 5 illustrates a process in which an initial operation of a secure boot process is performed after power is supplied according to some embodiments of the present disclosure.

Referring to FIG. 5, a first chiplet 100 may execute a bootloader if power is supplied to a system (S512). In some embodiments, a first secure core (e.g., the first secure core 120 of FIG. 2) of the first chiplet 100 may execute a bootloader stored in a secure domain of the first chiplet 100. Also, a second chiplet 200 may execute a bootloader if power is supplied to the system (S522). In some embodiments, a second secure core (e.g., the second secure core 220 of FIG. 2) of the second chiplet 200 may execute a bootloader stored in a secure domain of the second chiplet 200.

Thereafter, the first chiplet 100 may load and verify firmware stored in a non-volatile memory based on the bootloader (S514). In some embodiments, an integrity check may be performed using a public-key cryptography (PKC) method, a hash algorithm, and the like, and for example, the first chiplet 100 may verify integrity by calculating a hash value of firmware and decrypting and comparing a stored signature. Also, the second chiplet 200 may wait for firmware to be transmitted from the first chiplet 100 (S524). Since the second chiplet 200 is not connected to the non-volatile memory where firmware is stored, the second chiplet 200 may receive and execute verified firmware from the first chiplet 100. However, the present disclosure is not limited thereto.

Also, the first chiplet 100 may execute verified firmware (S516) and transmit the verified firmware to the second chiplet 200 (S518). The second chiplet 200 may receive firmware from the first chiplet 100 and execute the received firmware (S526). At this time, the first chiplet 100 may transmit the verified firmware through a first interface (e.g., the first interface 102 of FIG. 2).

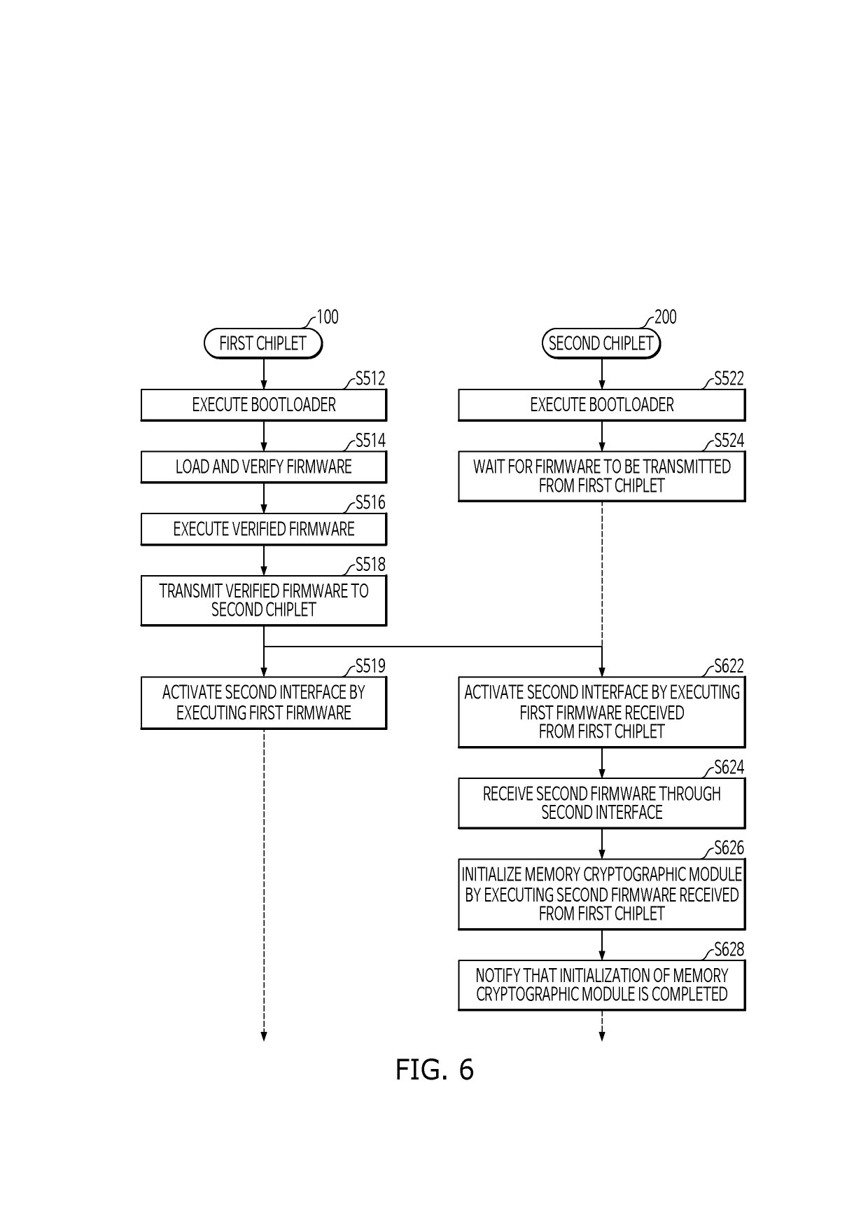

FIG. 6 illustrates a process in which a second interface is activated and a memory cryptographic module is initialized through a secure boot process after power is supplied according to some embodiments of the present disclosure. Descriptions redundant with descriptions above are briefly described or omitted.

In some embodiments, a non-volatile memory device connected to a first chiplet 100 may include first firmware for activation of a second interface that supports high-speed data transmission between the first chiplet 100 and a second chiplet 200 and second firmware associated with initial setting of a memory cryptographic module included in the second chiplet 200.

In some embodiments, the first interface includes an SPI (serial peripheral interface) interface, and the second interface may include a UCIe (universal chiplet interconnect express) interface, but is not limited thereto.

Referring to FIG. 6, the first chiplet 100 may execute a bootloader (S512) and load and verify firmware stored in the non-volatile memory device (S514). At this time, the first chiplet 100 may load and verify first firmware stored in the non-volatile memory device. Similarly, the second chiplet 200 may execute a bootloader (S522) and wait for firmware to be transmitted from the first chiplet 100 (S524).

Thereafter, the first chiplet 100 may execute verified firmware (S516) and transmit the verified firmware to the second chiplet 200 (S518). In some embodiments, the first chiplet 100 may transmit verified first firmware to the second chiplet to activate the second interface that supports high-speed data transmission. Also, the first chiplet 100 may activate the second interface by executing the first firmware (S519).

The second chiplet 200 may activate the second interface by executing the first firmware received from the first chiplet 100 (S622). After the first chiplet 100 and the second chiplet 200 activate the second interface by executing the first firmware, the first chiplet 100 and the second chiplet 200 may communicate with each other through the second interface.

Although not illustrated, the first chiplet 100 may transmit second firmware to the second chiplet 200 through the second interface for initial setting of a memory cryptographic module after the second interface is activated.

The second chiplet 200 receives the second firmware through the second interface (S624), and may initialize the memory cryptographic module by executing the second firmware received from the first chiplet 100 (S626). If initialization of the memory cryptographic module is completed, the second chiplet 200 may notify the first chiplet 100 that initialization of the memory cryptographic module is completed (S628). In some embodiments, a second secure core of the second chiplet 200 may determine whether initialization of the memory cryptographic module is completed, and if initialization of the memory cryptographic module is completed, notify that initialization of the memory cryptographic module is completed using a first mailbox (e.g., the first mailbox 140 of FIG. 2) through the second interface. However, the present disclosure is not limited thereto. Through this, a first secure core of the first chiplet 100 may confirm that initialization of the memory cryptographic module is completed.

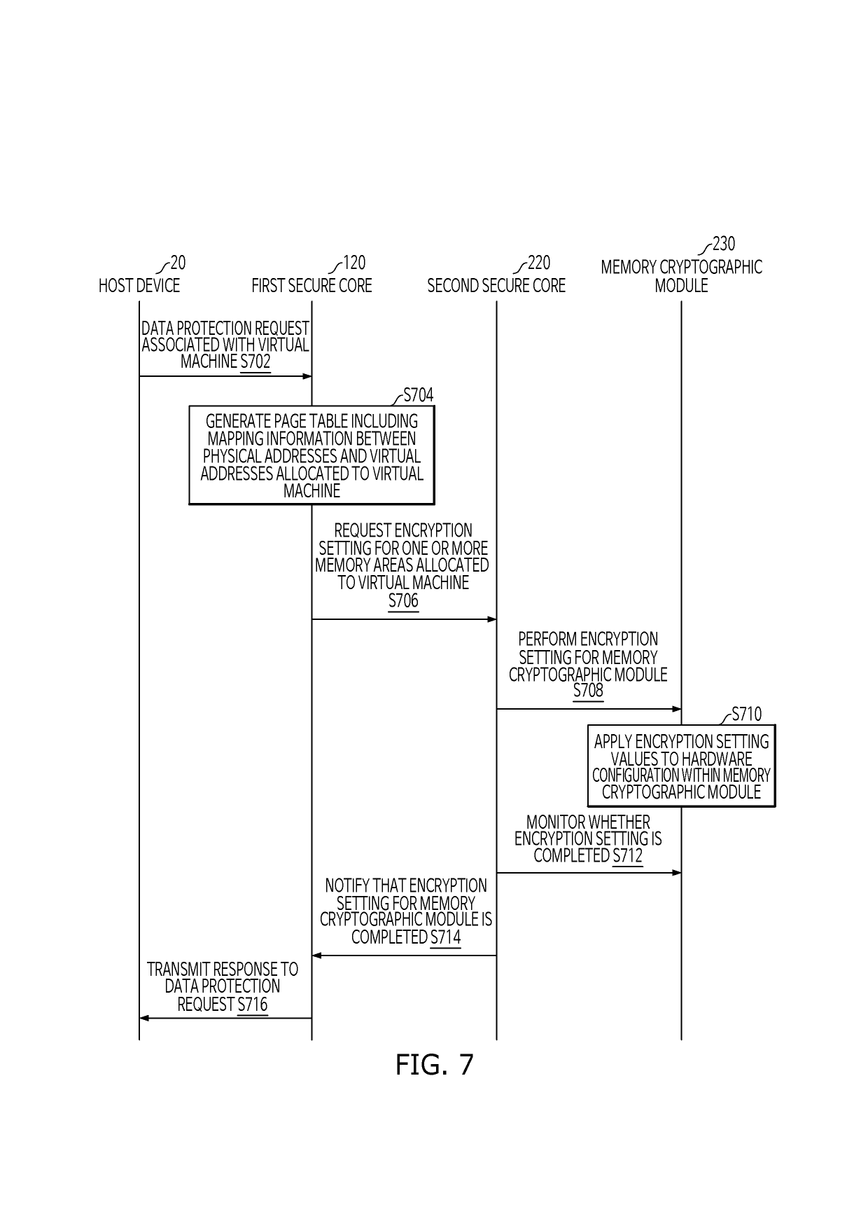

FIG. 7 illustrates a data protection process associated with a virtual machine according to some embodiments of the present disclosure. Descriptions redundant with descriptions above are briefly described or omitted.

Referring to FIG. 7, a host device 20 may request data protection associated with a virtual machine from a first secure core 120 (S702). In some embodiments, the host device 20 may transmit the corresponding request to the first secure core 120 through a third interface (e.g., the third interface 22 of FIG. 2). Here, a virtual machine (VM) means an independent virtual environment running on the host device 20, and data protection associated with a virtual machine may include safely managing memory data used by the corresponding virtual machine.

The first secure core 120 may, in response to receiving the data protection request associated with the virtual machine, generate a page table including mapping information between physical addresses and virtual addresses allocated to the corresponding virtual machine (S704). In some embodiments, the first secure core 120 may store the generated page table in a secure domain of a first chiplet 100. Additionally or alternatively, the first secure core 120 may transmit the generated page table to a second chiplet 200 so that it is stored in a secure domain of the second chiplet 200.

The first secure core 120 may request encryption setting for one or more memory areas allocated to the virtual machine from a second secure core 220 (S706). The second secure core 220 may, in response to receiving the encryption setting request from the first secure core 120, perform encryption setting for a memory cryptographic module 230 by controlling the memory cryptographic module 230 (S708).

In some embodiments, encryption setting for the memory cryptographic module 230 may be applied in various ways according to security requirements of a virtual machine. For example, the second secure core 220 may allocate an identifier for distinguishing, among the one or more memory areas, a specific memory area to which encryption is to be applied, and secure data isolation between different virtual machines may be achieved using a unique identifier for each virtual machine.

Also, the second secure core 220 may define a range of memory addresses to which encryption is to be applied, so that only a memory area used by a specific virtual machine is set as a data subject to encryption. For example, a method such as encrypting only a memory block where a major dataset used for artificial intelligence computation is stored may be applied, but is not limited thereto.

Also, the second secure core 220 may set a cryptographic algorithm to be applied to each of the one or more memory areas, and a symmetric key encryption method such as AES-GCM or a tag-based encryption method for guaranteeing data integrity between virtual machines may be applied, but is not limited thereto.

Also, the second secure core 220 may enhance data isolation between virtual machines by setting a unique cryptographic key for each of the one or more memory areas. For example, memory blocks used in different virtual machines may be encrypted using independent keys, and through this, a security threat occurring in one virtual machine may be prevented from spreading to another virtual machine.

The memory cryptographic module 230 may apply encryption setting values to a hardware configuration within the memory cryptographic module 230 (S710). In some embodiments, the memory cryptographic module 230 stores encryption setting values within the memory cryptographic module 230, and may apply the encryption setting values to a cryptographic accelerator (e.g., the cryptographic accelerator 238 of FIG. 2).

The second secure core 220 monitors whether the encryption setting of the memory cryptographic module 230 is completed (S712), and in response to determining that the encryption setting for the memory cryptographic module 230 is completed, may notify the first secure core 120 that the encryption setting for the memory cryptographic module 230 is completed (S714). In some embodiments, the second secure core 220 may notify the first secure core 120 that the encryption setting for the memory cryptographic module 230 is completed using a first mailbox through a second interface.

The first secure core 120 may, in response to the corresponding notification, transmit a response to the data protection request to the host device 20 through the third interface (S716).

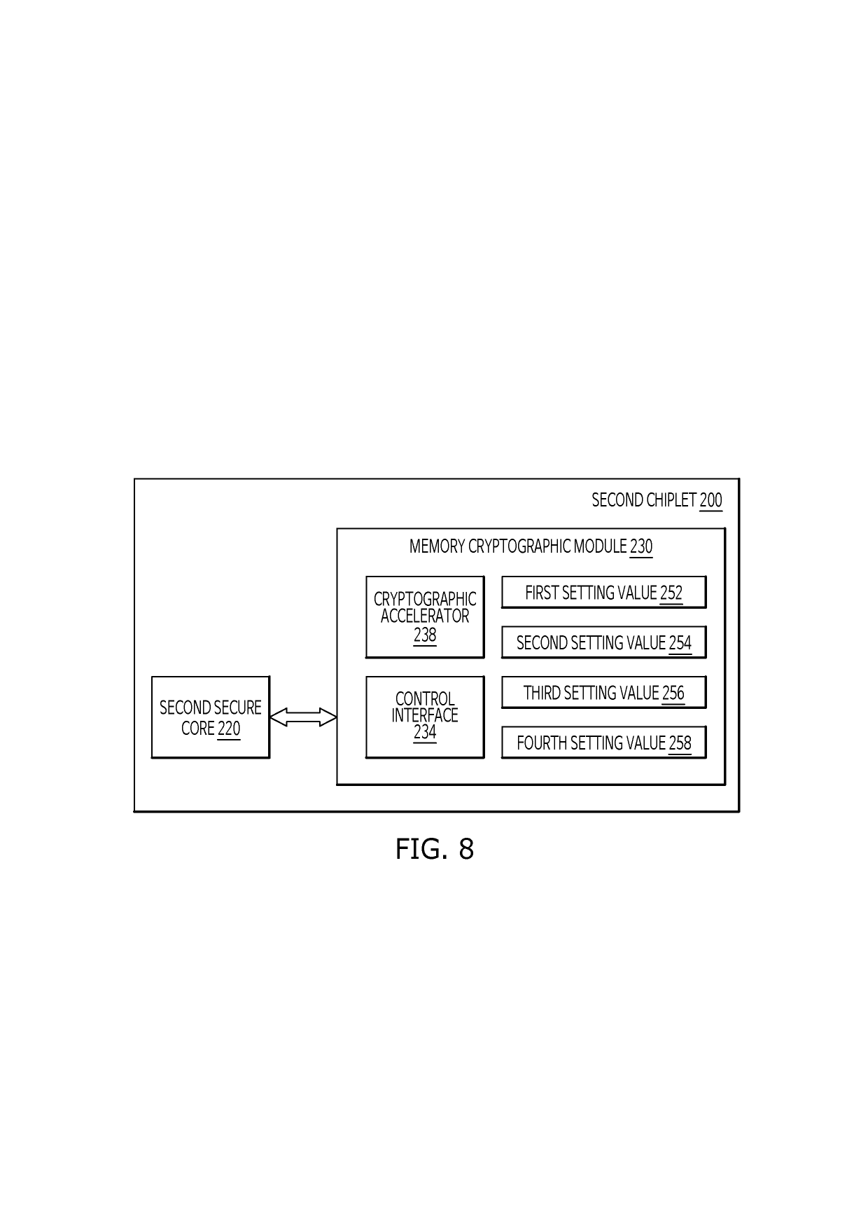

FIG. 8 illustrates a memory cryptographic module in which encryption setting values are stored according to some embodiments of the present disclosure. Descriptions redundant with descriptions above are briefly described or omitted.

Referring to FIG. 8, a second chiplet 200 may include a second secure core 220 and a memory cryptographic module 230. Although not illustrated, the second chiplet 200 may further include additional components.

The second secure core 220 may perform encryption setting for the memory cryptographic module 230 by controlling the memory cryptographic module 230. For example, the second secure core 220 may transmit first to fourth setting values 252, 254, 256, and 258 to the memory cryptographic module 230 through a control interface 234. The memory cryptographic module 230 may store the first to fourth setting values 252 to 258 and apply them to a cryptographic accelerator 238.

In some embodiments, the first setting value 252 may include a unique identifier allocated for each virtual machine. For example, a unique ID for each virtual machine such as VM-001, VM-002, and VM-003 may be stored as the first setting value 252, but is not limited thereto.

In some embodiments, the second setting value 254 may include information regarding one or more memory areas used by a specific virtual machine. For example, a memory address range such as 0x1000-0x1FFF for VM-001 and 0x2000-0x2FFF for VM-002 may be set, but is not limited thereto. The second setting value 254 may be stored in linkage with the first setting value 252.

In some embodiments, the third setting value 256 may include information regarding a cryptographic algorithm to be applied to each of the one or more memory areas. For example, it may be set in a way that AES-GCM is applied for VM-001 and AES-XTS is applied for VM-002, but is not limited thereto. The third setting value 256 may be stored in linkage with at least one of the first setting value 252 or the second setting value 254.

In some embodiments, the fourth setting value 258 may include information regarding a unique cryptographic key for each of the one or more memory area. The fourth setting value 258 may be stored in linkage with at least one of the first setting value 252, the second setting value 254, or the third setting value 256.

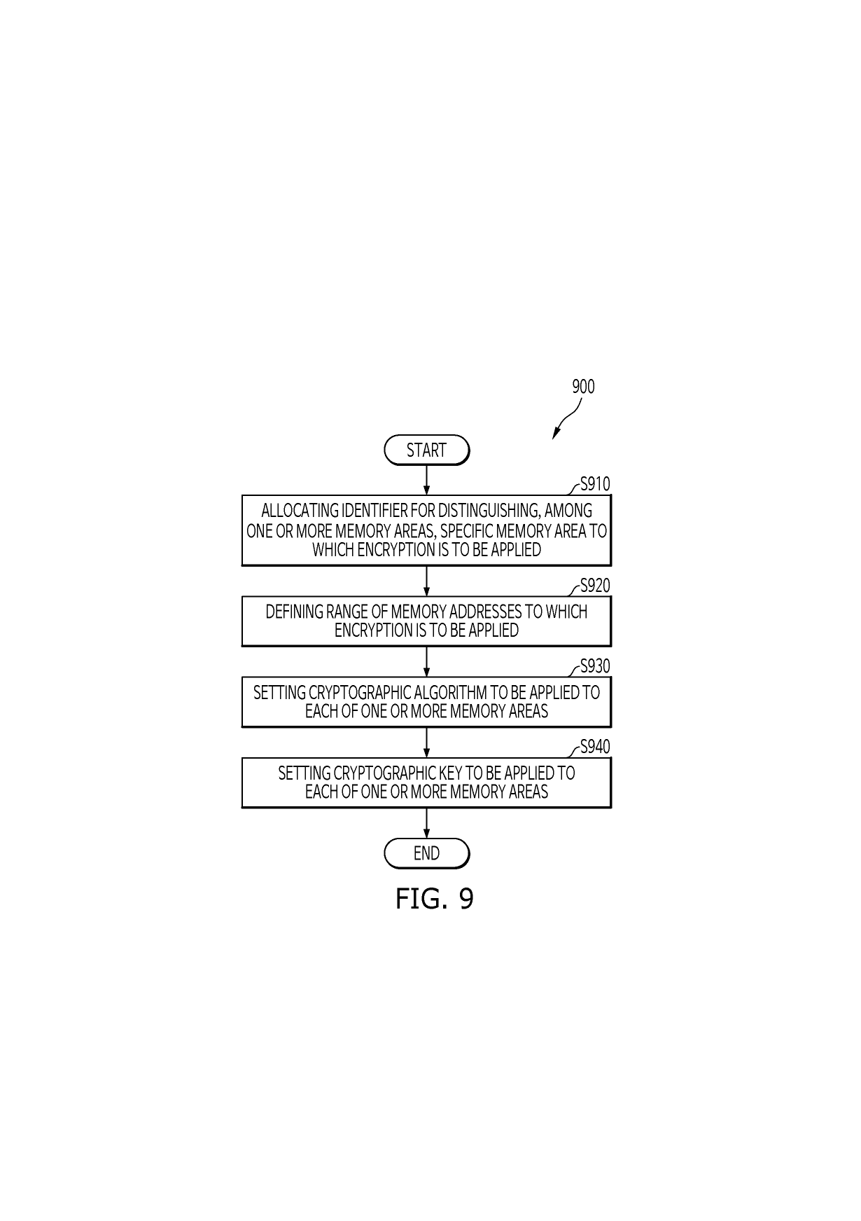

FIG. 9 illustrates an encryption setting method according to some embodiments of the present disclosure. Descriptions redundant with descriptions above are briefly described or omitted. An encryption setting method 900 of FIG. 9 may be performed by a second secure core (e.g., the second secure core 220 of FIG. 2) or a memory cryptographic module (e.g., the memory cryptographic module 230 of FIG. 2).

First, the second secure core or the memory cryptographic module may allocate an identifier for distinguishing, among the one or more memory areas, a specific memory area to which encryption is to be applied (S910). For example, an identifier for distinguishing a specific memory area to which encryption is to be applied may be allocated for each virtual machine.

Also, the second secure core or the memory cryptographic module may define a range of memory addresses to which encryption is to be applied (S920). For example, it may be set so that only a memory area used by a specific virtual machine becomes a data subject to encryption. As another example, a memory area to which encryption is to be applied may be defined according to an identifier allocated to a virtual machine.

Also, the second secure core or the memory cryptographic module may set a cryptographic algorithm to be applied to each of the one or more memory area (S930). For example, different cryptographic algorithms may be applied for each memory area.

Also, the second secure core or the memory cryptographic module may set a cryptographic key to be applied to each of the one or more memory areas (S940). For example, a unique cryptographic key may be set for each memory area.

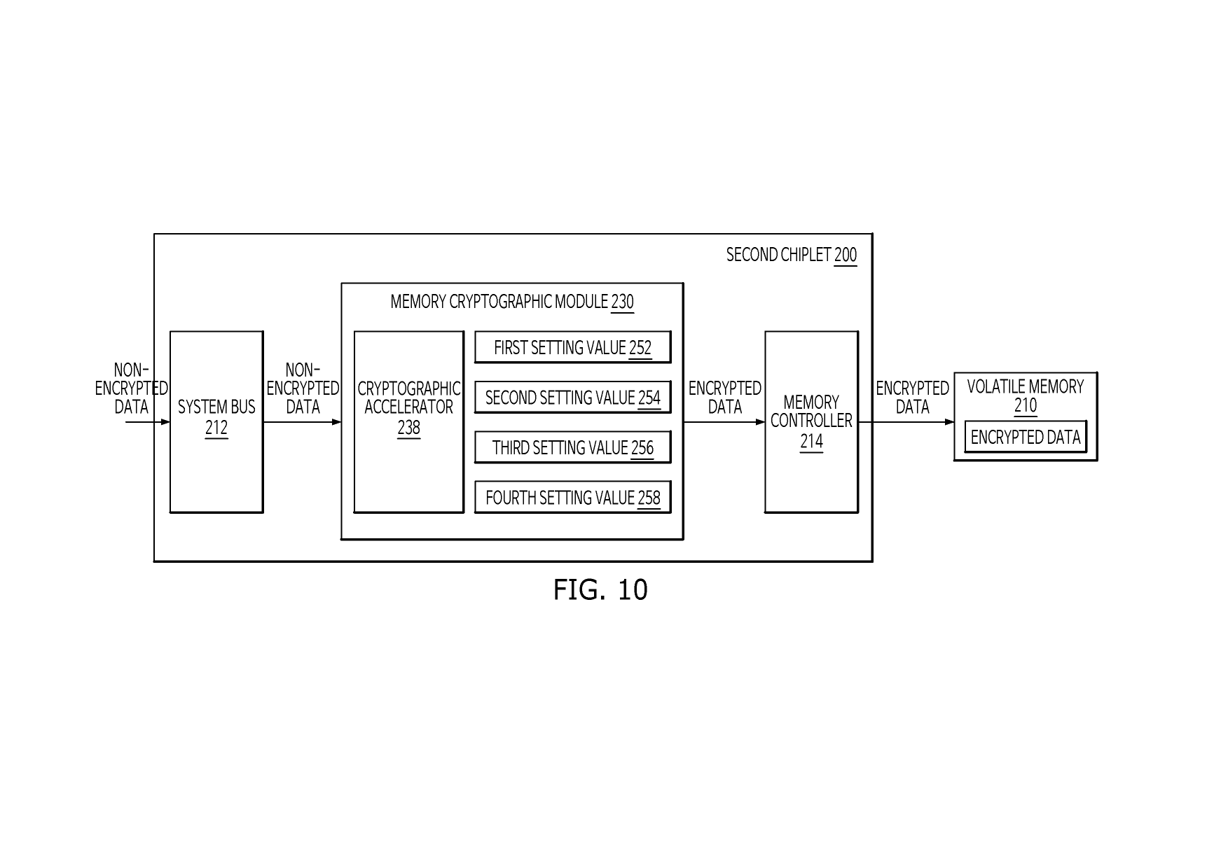

FIG. 10 illustrates a data encryption process according to some embodiments of the present disclosure. Descriptions redundant with descriptions above are briefly described or omitted.

Referring to FIG. 10, a second chiplet 200 may include a system bus 212, a memory cryptographic module 230, and a memory controller 214. Although not illustrated, the second chiplet 200 may further include additional components.

The second chiplet 200 receives non-encrypted data from an external component (e.g., the first chiplet 100 of FIG. 2) through the system bus 212, and after going through an encryption process, may store encrypted data in a volatile memory 210 through the memory controller 214. In some embodiments, the system bus 212 is hardware-configured so that non-encrypted data is not directly delivered to the memory controller 214, and may be designed so that it can be stored in an encrypted state after passing through the memory cryptographic module 230. However, the present disclosure is not limited thereto.

Looking at the encryption process, the second chiplet 200 may receive non-encrypted data through the system bus 212. Also, the memory cryptographic module 230 may receive non-encrypted data through an interface (e.g., the bus interface 232 of FIG. 2) configured to communicate with the system bus 212. The memory cryptographic module 230 may encrypt the received non-encrypted data. According to an embodiment, the memory cryptographic module 230 may encrypt non-encrypted data by applying first to fourth setting values 252 to 258 to a cryptographic accelerator 238.

In some embodiments, the memory cryptographic module 230 may determine whether received non-encrypted data is data subject to encryption. The memory cryptographic module 230 may, in response to determining that the received non-encrypted data is the data subject to encryption, perform encryption on the non-encrypted data through the cryptographic accelerator 238, and transmit the encrypted data to the memory controller 214. At this time, the memory cryptographic module 230 may transmit the encrypted data to the memory controller 214 through an interface (e.g., the memory interface 236 of FIG. 2) configured to communicate with the memory controller 214.

In some embodiments, whether data received by the memory cryptographic module 230 is the data subject to encryption may be determined based on whether a physical address of the corresponding data is included in a preset encrypted memory area associated with one or more memory areas, which is allocated to the virtual machine. The memory cryptographic module 230 may determine whether the physical address of the corresponding data is included in the preset encrypted memory area based on the first to fourth setting values 252 to 258. The cryptographic accelerator 238 may perform data encryption based on a cryptographic algorithm and a cryptographic key that are preset according to the third setting value 256 and the fourth setting value 258, but is not limited thereto.

The memory controller 214 may store the received encrypted data in the memory area of the volatile memory 210.

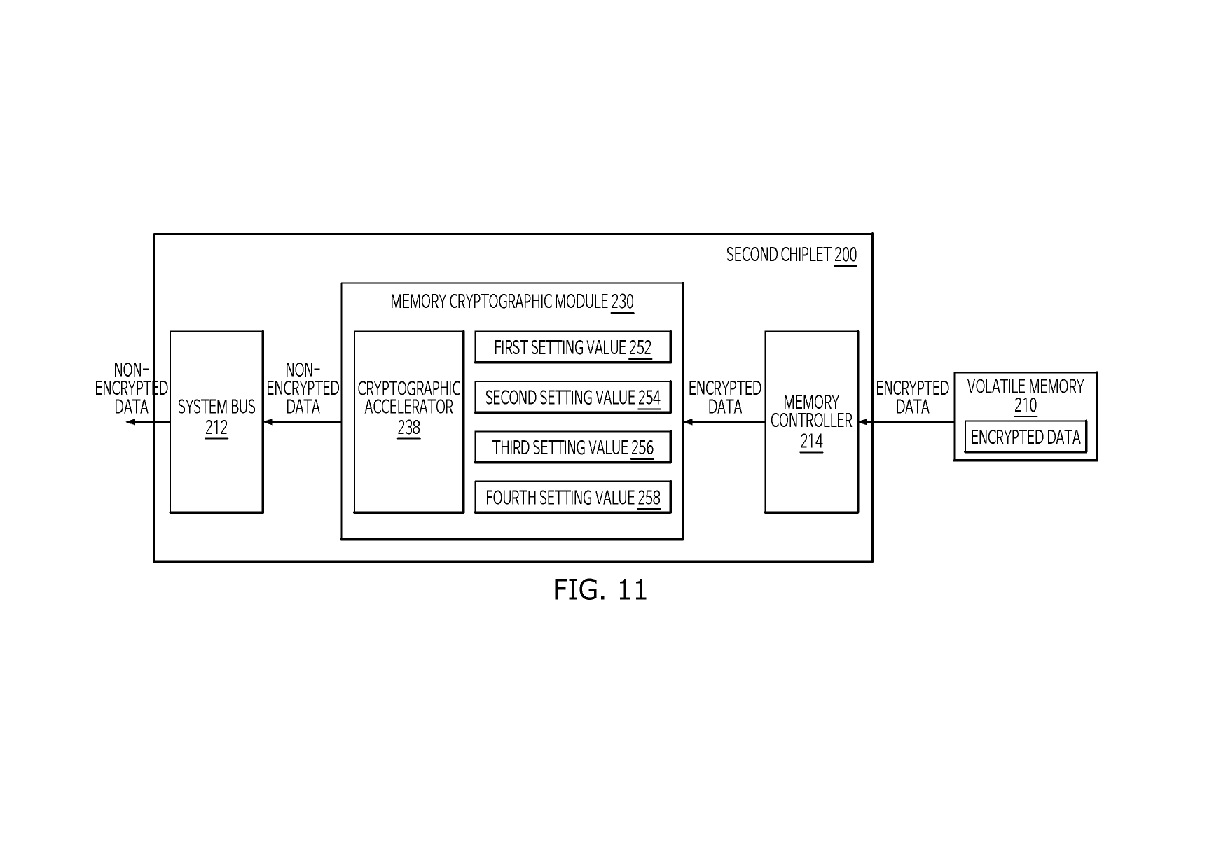

FIG. 11 illustrates a data decryption process according to some embodiments of the present disclosure. Descriptions redundant with descriptions above are briefly described or omitted.

Referring to FIG. 11, a second chiplet 200 may include a system bus 212, a memory cryptographic module 230, and a memory controller 214. Although not illustrated, the second chiplet 200 may further include additional components.

The second chiplet 200 receives encrypted data from a volatile memory 210 through the memory controller 214, and after going through a decryption process, may deliver non-encrypted data through the system bus 212 to an external component (e.g., the first chiplet 100 of FIG. 2) through the system bus 212.

Looking at the decryption process, the second chiplet 200 may read encrypted data through the memory controller 214. Also, the memory cryptographic module 230 may receive encrypted data through a memory interface (e.g., the memory interface 236 of FIG. 2). The memory cryptographic module 230 may decrypt the received encrypted data. According to an embodiment, the memory cryptographic module 230 may decrypt the encrypted data by applying first to fourth setting values 252 to 258 to a cryptographic accelerator 238.

In some embodiments, the memory cryptographic module 230 may, if received data is encrypted data, decrypt the data through the cryptographic accelerator 238, and transmit the decrypted data to the system bus 212. At this time, the memory cryptographic module 230 may deliver the decrypted data to an external component through an interface (e.g., the bus interface 232 of FIG. 2) configured to communicate with the system bus 212.

Non-encrypted data may be transmitted to an external component through the system bus 212.

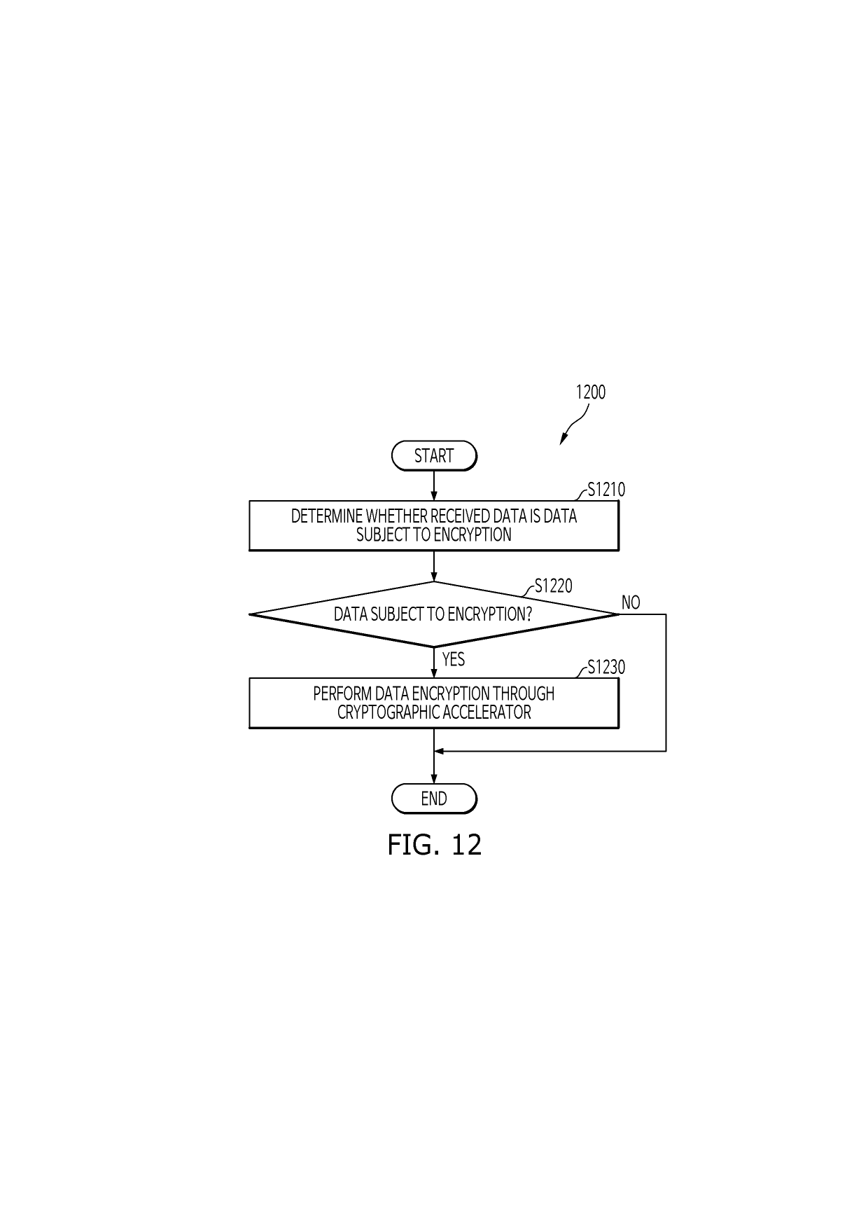

FIG. 12 illustrates a data encryption method according to some embodiments of the present disclosure. Descriptions redundant with descriptions above are briefly described or omitted. A data encryption method 1200 of FIG. 12 may be performed by a memory cryptographic module (e.g., the memory cryptographic module 230 of FIG. 2) of a second chiplet (e.g., the second chiplet 200 of FIG. 2).

Referring to FIG. 12, the memory cryptographic module may determine whether received data is data subject to encryption (S1210). According to an embodiment, the memory cryptographic module may receive data from a system bus (e.g., the system bus 212 of FIG. 2) within the second chiplet through a bus interface (e.g., the bus interface 232 of FIG. 2).

In some embodiments, the memory cryptographic module may determine whether data is data subject to encryption based on whether a physical address of the received data is included in a preset encrypted memory area. The memory cryptographic module may determine whether the physical address of the corresponding data is included in the preset encrypted memory area based on setting values stored therein.

Thereafter, in step S1220, the memory cryptographic module may, in response to determining that the received data is the data subject to encryption (YES), perform step S1230. In contrast, if the memory cryptographic module does not determine that the received data is the data subject to encryption (NO), the method 1200 may end.

The memory cryptographic module may, in response to determining that the received data is the data subject to encryption, perform data encryption through a cryptographic accelerator (e.g., the cryptographic accelerator 238 of FIG. 2) (S1230). In some embodiments, the memory cryptographic module may perform data encryption by applying setting values stored therein to the cryptographic accelerator.

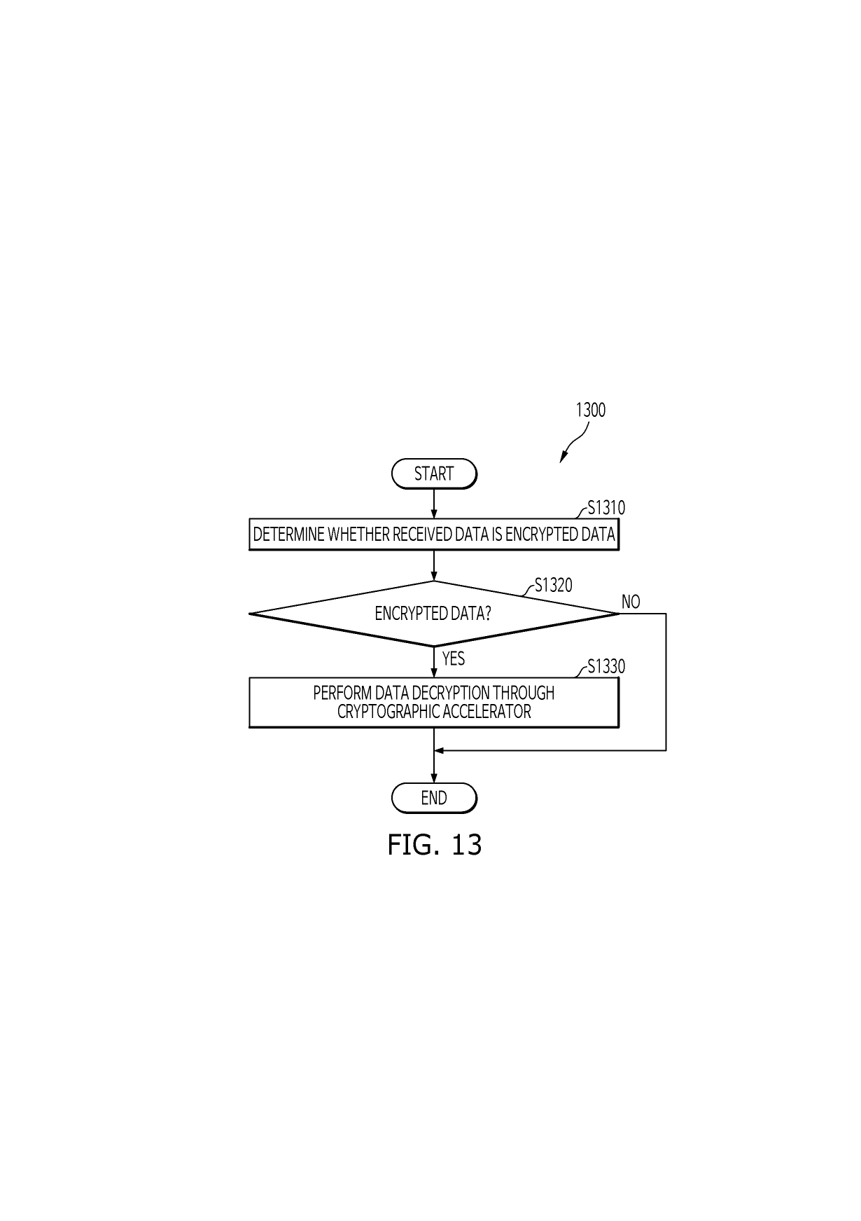

FIG. 13 illustrates a data decryption method according to some embodiments of the present disclosure. Descriptions redundant with descriptions above are briefly described or omitted. A data decryption method 1300 of FIG. 13 may be performed by a memory cryptographic module (e.g., the memory cryptographic module 230 of FIG. 2) of a second chiplet (e.g., the second chiplet 200 of FIG. 2).

Referring to FIG. 13, the memory cryptographic module may determine whether received data is encrypted data (S1310). According to an embodiment, the memory cryptographic module may receive data from a memory controller (e.g., the memory controller 214 of FIG. 2) within the second chiplet through a memory interface (e.g., the memory interface 236 of FIG. 2).

Thereafter, in step S1320, the memory cryptographic module may, in response to determining that the received data is the encrypted data (YES), perform step S1330. In contrast, if the memory cryptographic module does not determine that the received data is the encrypted data (NO), the method 1300 may end.

The memory cryptographic module may, in response to determining that the received data is the encrypted data, perform data decryption through a cryptographic accelerator (e.g., the cryptographic accelerator 238 of FIG. 2) (S1330). In some embodiments, the memory cryptographic module may perform data decryption by applying setting values stored therein to the cryptographic accelerator.

The flowcharts described above and descriptions above are only an example, and in some embodiments, may be implemented differently. For example, in some embodiments, an order of each step may be changed, some steps may be performed repeatedly, some steps may be omitted, or some steps may be added.

The above-described method may be provided as a computer program stored in a computer-readable recording medium for execution in a computer. The medium may continuously store a program executable by a computer, or temporarily store the program for execution or download. Also, the medium may be various recording means or storage means in a form where a single or several hardwares are combined, but is not limited to a medium directly connected to a certain computer system, and may exist distributed on a network. Examples of the medium may include magnetic media such as a hard disk, a floppy disk, and a magnetic tape, optical recording media such as a CD-ROM and a DVD, magneto-optical media such as a floptical disk, and those configured to store program instructions including ROM, RAM, flash memory, and the like. Also, as examples of other media, recording media or storage media managed by an app store distributing applications or sites and servers supplying or distributing other various softwares may be included.

Methods, operations, or techniques of the present disclosure may also be implemented by various means. For example, such techniques may be implemented in hardware, firmware, software, or combinations thereof. Those skilled in the art will understand that various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends on the specific application and design requirements imposed on the overall system. Those skilled in the art may implement the described functionality in various ways for each specific application, but such implementation should not be interpreted as causing a departure from the scope of the present disclosure.

In hardware implementation, processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, a computer, or combinations thereof.

Accordingly, various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination of those designed to perform functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other configuration combination.

In firmware and/or software implementation, the techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), a magnetic or optical data storage device, and the like. The instructions may be executable by one or more processors, and may cause the processor(s) to perform certain aspects of the functionality described in the present disclosure.

If implemented in software, the above-described techniques may be stored as one or more instructions or code on a computer-readable medium or may be transmitted through a computer-readable medium. Computer-readable media include both computer storage media and communication media including any medium that facilitates transfer of a computer program from one place to another. Storage media may be any available media that can be accessed by a computer. By way of non-limiting example, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line, or wireless technologies such as infrared, radio, and microwave are included within the definition of the medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, a hard disk, a removable disk, a CD-ROM, or any other form of storage medium known. An exemplary storage medium may be connected to the processor so that the processor can read information from the storage medium or write information to the storage medium. Alternatively, the storage medium may be integrated into the processor. The processor and the storage medium may exist within an ASIC. The ASIC may exist within a user terminal. Alternatively, the processor and the storage medium may exist as separate components in a user terminal.

Although the embodiments described above have been described as utilizing aspects of the currently disclosed subject matter in one or more standalone computer systems, the present disclosure is not limited thereto, and may be implemented in conjunction with any computing environment such as a network or a distributed computing environment. Furthermore, aspects of the subject matter in the present disclosure may be implemented in a plurality of processing chips or devices, and storage may be similarly affected across a plurality of devices. Such devices may include PCs, network servers, and portable devices.

In the present specification, the present disclosure has been described with reference to some embodiments, but various modifications and changes may be made within a range that does not depart from the scope of the present disclosure that can be understood by a person skilled in the art of the technical field to which the present disclosure belongs. Also, such modifications and changes should be considered to fall within the scope of the claims attached to the present specification.

What is claimed is:

1. A chiplet system including a plurality of chiplets, the chiplet system comprising:
a first chiplet including a ROM in which a bootloader is stored and a first secure core, the first chiplet being connected to a non-volatile memory in which a firmware is stored;
a second chiplet comprising:
a memory controller configured to control operation of a volatile memory;
a system bus through which data to be stored in the volatile memory is transmitted and received;
a memory cryptographic module configured to receive data from the system bus, encrypt the received data, and transmit the encrypted data to the memory controller; and
a second secure core configured to control the memory cryptographic module;
a first interface configured to connect the first chiplet and the second chiplet; and
a second interface configured to connect the first chiplet and the second chiplet, the second interface being set with a communication speed faster than a communication speed of the first interface,
wherein the first secure core is configured to execute the bootloader, load and verify firmware stored in the non-volatile memory based on the bootloader, and transmit the verified firmware to the second chiplet, and
the second secure core is further configured to activate the second interface based on first firmware received through the first interface, and initialize the memory cryptographic module based on second firmware received through the second interface.

2. The chiplet system as claimed in claim 1, wherein the first chiplet further comprises a first mailbox, and
the second secure core is configured to determine whether initialization of the memory cryptographic module is completed, and if the initialization of the memory cryptographic module is completed, notify that the initialization of the memory cryptographic module is completed using the first mailbox through the second interface.

3. The chiplet system as claimed in claim 2, wherein the second chiplet further comprises a second mailbox,
the chiplet system further comprising a third interface configured to connect the first chiplet and a host device,
the first secure core is further configured to:
receive a data protection request associated with a virtual machine from the host device through the third interface;
in response to receiving the data protection request, generate a page table including mapping information between physical addresses and virtual addresses allocated to the virtual machine; and
request encryption setting for one or more memory areas allocated to the virtual machine using the second mailbox through the second interface.

4. The chiplet system as claimed in claim 3, wherein the second secure core is further configured to:
in response to receiving the encryption setting request, perform encryption setting for the memory cryptographic module,
determine whether the encryption setting for the memory cryptographic module is completed; and
in response to determining that the encryption setting for the memory cryptographic module is completed, notify that the encryption setting for the memory cryptographic module is completed using the first mailbox through the second interface, and
the first secure core is further configured to transmit a response to the data protection request through the third interface.

5. The chiplet system as claimed in claim 4, wherein performing the encryption setting for the memory cryptographic module comprises at least one of:
allocating an identifier for distinguishing, among the one or more memory areas, a specific memory area to which encryption is to be applied;
defining a range of memory addresses to which encryption is to be applied;
setting a cryptographic algorithm to be applied to each of the one or more memory areas; or
setting a cryptographic key to be applied to each of the one or more memory areas.

6. The chiplet system as claimed in claim 3, wherein the memory cryptographic module comprises a bus interface configured to communicate with the system bus, a memory interface configured to communicate with the memory controller, and a cryptographic accelerator, and
the memory cryptographic module is further configured to determine whether data received through the bus interface is data subject to encryption, in response to determining that the data received through the bus interface is the data subject to encryption, perform encryption on the data through the cryptographic accelerator, and transmit the encrypted data to the memory controller through the memory interface.

7. The chiplet system as claimed in claim 6, wherein whether the data received through the bus interface is the data subject to encryption is determined based on whether a physical address of the data is included in a preset encrypted memory area associated with the one or more memory areas, and
the cryptographic accelerator performs data encryption based on a preset cryptographic key and a preset cryptographic algorithm.

8. The chiplet system as claimed in claim 3, wherein the memory cryptographic module comprises a bus interface configured to communicate with the system bus, a memory interface configured to communicate with the memory controller, and a cryptographic accelerator, and
the memory cryptographic module is further configured to, if data received through the memory interface is encrypted data, perform data decryption through the cryptographic accelerator, and transmit the decrypted data to the system bus through the bus interface.

9. The chiplet system as claimed in claim 3, wherein the third interface comprises a PCIe (peripheral component interconnect express) interface and is configured to receive a data protection request associated with a trusted execution environment from the host device based on a security protocol.

10. The chiplet system as claimed in claim 1, wherein the first interface is an interface configured so that the first chiplet and the second chiplet communicate with each other in a process of booting or system initialization, and
after the second interface is activated, the first chiplet and the second chiplet communicate with each other through the second interface.

11. The chiplet system as claimed in claim 10, wherein the first interface comprises a serial peripheral interface (SPI), and
the second interface comprises a universal chiplet interconnect express (UCIe) interface.

12. A data security method of a chiplet system including a first chiplet and a second chiplet, the data security method comprising:
executing, by a first secure core of the first chiplet, a bootloader stored in a read-only memory (ROM) included in the first chiplet;
loading and verifying, by the first secure core, firmware stored in a non-volatile memory connected to the first chiplet based on the bootloader;
transmitting, by the first secure core, the verified firmware to the second chiplet through a first interface;
receiving, by a second secure core of the second chiplet, first firmware through the first interface and activating a second interface based on the first firmware; and
receiving, by the second secure core, second firmware through the second interface and initializing a memory cryptographic module included in the second chiplet based on the second firmware,
wherein the first interface is configured to connect the first chiplet and the second chiplet, and
the second interface is configured to connect the first chiplet and the second chiplet, a communication speed faster than the first interface being set for a communication speed of the second interface.

13. The data security method as claimed in claim 12, wherein the first chiplet further comprises a first mailbox,
the method further comprising:
determining, by the second secure core, whether initialization of the memory cryptographic module is completed; and
if the initialization of the memory cryptographic module is completed, notifying, by the second secure core, that the initialization of the memory cryptographic module is completed using the first mailbox through the second interface.

14. The data security method as claimed in claim 13, wherein the second chiplet further comprises a second mailbox,
the method further comprising:
receiving, by the first secure core, a data protection request associated with a virtual machine from a host device through a third interface;
in response to receiving the data protection request, generating, by the first secure core, a page table including mapping information between physical addresses and virtual addresses allocated to the virtual machine; and
requesting, by the first secure core, encryption setting for one or more memory areas allocated to the virtual machine using the second mailbox through the second interface.

15. The data security method as claimed in claim 14, further comprising:
in response to receiving the encryption setting request, performing, by the second secure core, encryption setting for the memory cryptographic module;
determining, by the second secure core, whether the encryption setting for the memory cryptographic module is completed;
in response to determining that the encryption setting for the memory cryptographic module is completed, notifying, by the second secure core, that the encryption setting for the memory cryptographic module is completed using the first mailbox through the second interface; and
transmitting, by the first secure core, a response to the data protection request through the third interface.

16. The data security method as claimed in claim 15, wherein the performing the encryption setting for the memory cryptographic module comprises at least one of:
allocating an identifier for distinguishing, among the one or more memory areas, a specific memory area to which encryption is to be applied;
defining a range of memory addresses to which encryption is to be applied;
setting a cryptographic algorithm to be applied to each of the one or more memory areas; or
setting a cryptographic key to be applied to each of the one or more memory areas.

17. The data security method as claimed in claim 14, wherein the memory cryptographic module comprises a bus interface configured to communicate with a system bus, a memory interface configured to communicate with a memory controller, and a cryptographic accelerator, and
the method further comprising:
determining, by the memory cryptographic module, whether data received through the bus interface is data subject to encryption;
in response to determining that the data received through the bus interface is the data subject to encryption, performing, by the memory cryptographic module, encryption on the data through the cryptographic accelerator; and
transmitting, by the memory cryptographic module, the encrypted data to the memory controller through the memory interface.

18. The data security method as claimed in claim 17, wherein whether the data received through the bus interface is the data subject to encryption is determined based on whether a physical address of the data is included in a preset encrypted memory area associated with the one or more memory areas, and
the cryptographic accelerator is configured to perform data encryption based on a preset cryptographic key and a preset cryptographic algorithm.

19. The data security method as claimed in claim 14, wherein the memory cryptographic module comprises a bus interface configured to communicate with a system bus, a memory interface configured to communicate with a memory controller, and a cryptographic accelerator, and
the method further comprising:
if data received through the memory interface is encrypted data, performing, by the memory cryptographic module, data decryption through the cryptographic accelerator; and
transmitting, by the memory cryptographic module, the decrypted data to the system bus through the bus interface.

20. The data security method as claimed in claim 12, wherein the first interface is an interface configured so that the first chiplet and the second chiplet communicate with each other in a process of booting or system initialization, and
after the second interface is activated, the first chiplet and the second chiplet communicate with each other through the second interface.
